(19) United States
(12) Patent Application Publication
(10) Pub. No.: US 2026/0057098 A1
(43) Pub. Date: Feb. 26, 2026

(54) COMPUTATIONAL STORAGE SYSTEM, OPERATION METHOD THEREOF, AND ELECTRONIC DEVICE

(71) Applicant: Samsung Electronics Co., Ltd., Suwon-si (KR)

(72) Inventors: Sooyoung Ji, Suwon-si (KR); Youngsik Moon, Suwon-si (KR); Jongkeun Ahn, Suwon-si (KR)

(21) Appl. No.: 19/305,328

(22) Filed: Aug. 20, 2025

(30) Foreign Application Priority Data
Aug. 26, 2024 (KR) 10-2024-0114489

(51) Int. Cl. G06F 21/62; H04L 9/40

(52) U.S. Cl. CPC G06F 21/6227; H04L 63/1491

(57) ABSTRACT

A computational storage system includes a storage device storing a plurality of neural network models as well as base data and an event table both corresponding to each of the plurality of neural network models, and a computing device configured to generate inference video data corresponding to original video data, based on the plurality of neural network models, the base data, and the event table, wherein the computing device is further configured to, when an abnormal access to the computational storage system is identified, generate fake inference video data based on a security level of the abnormal access and output the generated fake inference video data, and wherein the security level indicates a data leakage path of the abnormal access.

### CROSS-REFERENCE TO RELATED APPLICATION

This application is based on and claims priority under 35 U.S.C. § 119 to Korean Patent Application No. 10-2024-0114489, filed on Aug. 26, 2024, in the Korean Intellectual Property Office, the entirety of which is incorporated by reference herein.

### BACKGROUND

In electronic devices including storage devices and host devices, instructions (or programs) and data are stored in the storage devices, and to perform data processing based on the instructions, the instructions and the data need to be transmitted from the storage devices to the host devices. Accordingly, even when the processing speed of the host devices increases, data transfer rates between the host devices and the storage devices may act as an obstacle to performance improvement and thus may limit the throughput of the whole systems. To solve such an issue, researches are being conducted on computational storage systems including both computing devices capable of processing data and existing components of storage devices according to the related art together. As a result of data processing by computing devices due to requests from host devices, a variety of multimedia data may be generated. Multimedia data is large-volume data in general and thus requires great data storage spaces when stored in storage devices.

### SUMMARY

When storage spaces, in which multimedia data is stored in storage devices, are not efficiently managed, a lack of storage spaces may lead to an issue of deterioration in the performance of the whole electronic devices including computational storage systems. In addition, for purposes of this disclosure, it has been recognized that it is difficult to convert multimedia data into strongly secure data due to the relatively large data size thereof, and there is also an issue of vulnerable data security due to the theft and hacking of storage devices. Therefore, to solve such issues, for purposes of this disclosure, it has been recognized that there is a need to develop a method of preventing data leakage due to an abnormal access (for example, an access due to the theft and hacking of devices) simultaneously with efficiently managing a storage space of a storage device), when multimedia data is stored.

Some aspects of the present disclosure relate to computational storage systems for preventing data leakage of the computational storage system (or a storage device) by generating fake inference video data when an abnormal access to the computational storage system (or the storage device) is detected, operation methods of the computational storage systems, and electronic devices.

Some aspects of the present disclosure provide a computational storage system for efficiently managing a storage space in a storage device, based on a neural network model, and preventing the leakage of data stored in a storage device due to an abnormal access (for example, an access due to the theft and hacking of the device), based on the neural network model, an operation method of the computational storage system, and an electronic device.

The present disclosure is not limited to the above aspects, and the above and other aspects of the inventive concept will be clearly understood by those of ordinary skill in the art from the following descriptions.

According to some implementations of the present disclosure, there is provided a computational storage system including a storage device configured to store a plurality of neural network models and a plurality of base data, wherein the plurality of base data respectively correspond to the plurality of neural network models, and wherein the plurality of base data comprise different respective portions of original video data; and a computing device configured to: based on identification of an abnormal access to the computational storage system, generate fake inference video data using a first neural network model of the plurality of neural network models, wherein the first neural network model corresponds to first base data, of the plurality of base data, that changes at least a portion of second base data, of the plurality of base data, for which video generation is requested through the abnormal access; and output the generated fake inference video data.

According to some implementations of the present disclosure, there is provided an operation method of a computational storage system configured to store a plurality of neural network models, the operation method comprising: receiving a data request through an abnormal access to the computational storage system, wherein the data request indicates a request to generate video data using a target neural network model of the plurality of neural network models; identifying a security level of the abnormal access; generating fake inference video data using an alternative neural network model, different from the target neural network model, based on the security level; and outputting the fake inference video data, wherein the security level indicates a data leakage path of the abnormal access.

According to some implementations of the present disclosure, there is provided an electronic device including a memory storing a plurality of neural network models; and a processor configured to: generate inference video data corresponding to original video data, based on base data and an event table that are generated from the original video data, by using the plurality of neural network models; based on identification of an abnormal access to the memory, select a first neural network model of the plurality of neural network models; and generate and output fake inference video data based on a security level of the abnormal access.

### BRIEF DESCRIPTION OF THE DRAWINGS

Embodiments will be more clearly understood from the following detailed description taken in conjunction with the accompanying drawings in which:

FIG. 1 is a block diagram illustrating an electronic device according to some implementations;

FIG. 2 is a block diagram illustrating a computational storage system according to some implementations;

FIG. 3 is a diagram illustrating operations of a computational storage system, according to some implementations;

FIG. 4A is a diagram illustrating operations of a computational storage system, according to some implementations;

FIG. 4B illustrates an example of an event table of a computational storage system, according to some implementations;

FIG. 5 illustrates an example of a neural network model structure according to some implementations;

FIG. 6 is a flowchart illustrating an operation method of a computational storage system, according to some implementations;

FIG. 7 is a diagram illustrating operations of a computational storage system, according to some implementations;

FIG. 8 is a diagram illustrating operations of a computational storage system, according to some implementations;

FIG. 9 is a diagram illustrating operations of a computational storage system, according to some implementations;

FIG. 10 illustrates an example of original inference video data according to some implementations;

FIGS. 11A to 11C each illustrate an example of fake inference video data according to some implementations; and

FIG. 12 is a block diagram illustrating an electronic device according to another embodiment.

### DETAILED DESCRIPTION

Hereinafter, examples will be described in detail with reference to the accompanying drawings.

As used herein, the phrase “generating a neural network model based on base data and an event table” may refer to training a neural network model based on base data and an event table.

A computational storage system 200 may generate inference video data (corresponding to original video data) based on base data and an event table by using at least one neural network model, in response to receiving a request from a host device 100 or to the input (or generation) of the original video data to the computational storage system 200.

As used herein, the term “abnormal access” may refer to an access (for example, a data read request by an intruder other than the host device 100) to the computational storage system 200 (or a storage device 210) by an entity (for example, an intruder) not having undergone a normal authentication procedure.

As used herein, the term “target neural network model” may refer to a neural network model for generating data (for example, inference video data) requested by an abnormal access, from among a plurality of neural network models stored in the computational storage system 200 (or the storage device 210).

As used herein, the term “model list” may refer to a list including at least one neural network model for generating inference video data similar to inference video data generated by each of the plurality of neural network models.

Herein, a generation time-data set may include generation time and a data set for base data and an event table, which correspond to the generation time. Herein, the generation time means the generation time of the original video data corresponding to the inference video data generated by each of the neural network models (for example, the target neural network model, or each of at least one neural network model included in the model list). Hereinafter, the “time-data set” may be also referred to as “time-associated base data”.

As used herein, the term “target generation time” may refer to generation time of data (for example, video data) for which a request (for example, a read request) is made by an abnormal access.

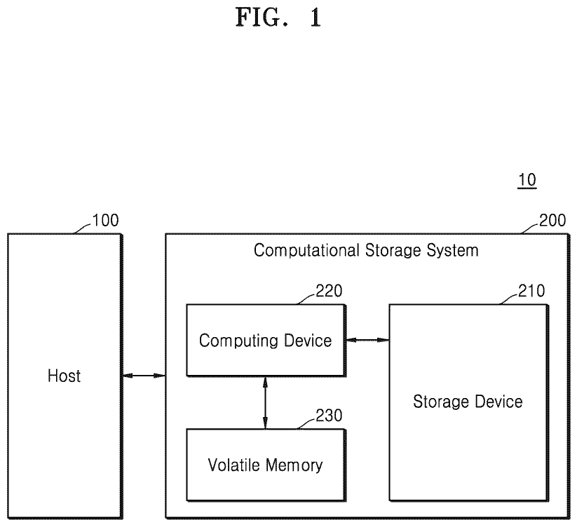

FIG. 1 is a block diagram illustrating an electronic device. Referring to FIG. 1, an electronic device 10 may include a host device 100 and a computational storage system 200.

The electronic device 10 may include a personal computer (PC), a data server, an ultra-mobile PC (UMPC), a workstation, a netbook, a network-attached storage (NAS), a smart television, an Internet-of-Things (IoT) device, a portable electronic device, or the like. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, or the like.

The host device 100 may manage operations of the electronic device 10. The host device 100 may store data in the computational storage system 200 and may read data from the computational storage system 200. For example, the host device 100 may store a write request and data to be written in the computational storage system 200 or may transmit a read request to the computational storage system 200. In addition, the host device 100 may allocate a task and data to the computational storage system 200 and may control the computational storage system 200 to cause the computational storage system 200 to perform the task. For example, the host device 100 may transmit, to the computational storage system 200, data to be processed by the computational storage system 200 and a data processing request for performing a task together, or may transmit, to the computational storage system 200, a data processing request for data already stored in the computational storage system 200.

In some implementations, the host device 100 transmits an inference video generation request to the computational storage system 200. The inference video generation request may be a request for a computing device 220 in the computational storage system 200 to generate inference video data corresponding to original video data and store the inference video data in the storage device 210. The inference video generation request may be transmitted from the host device 100 to the computational storage system 200 according to the selection/request of a function corresponding thereto by a user.

In some implementations, the host device 100 transmits a fake inference video data generation request to the computational storage system 200.

In some implementations, the host device 100 gives, to or for each abnormal access, a security code corresponding thereto. For example, a first security code may be given to an abnormal access due to the leakage of authentication on a website, a second security code may be given to an abnormal access due to the leakage of hardware, and a third security code may be given to an abnormal access due to the leakage of authentication on a network.

The host device 100 may be implemented by a central processing unit (CPU), a processor, a micro-processor, an application processor (AP), a system-on-a-chip (SoC), or the like.

The computational storage system 200 may include a storage device 210, a computing device 220, and volatile memory 230. The computational storage system 200 may be referred to as a computational storage device. The computational storage system 200 may store or process data in response to a request from the host device 100. In some implementations, the computational storage system 200 is implemented as a storage acceleration platform that accelerates data processing by internally storing and processing data. For example, the computational storage system 200 may include a smart solid-state drive (SSD).

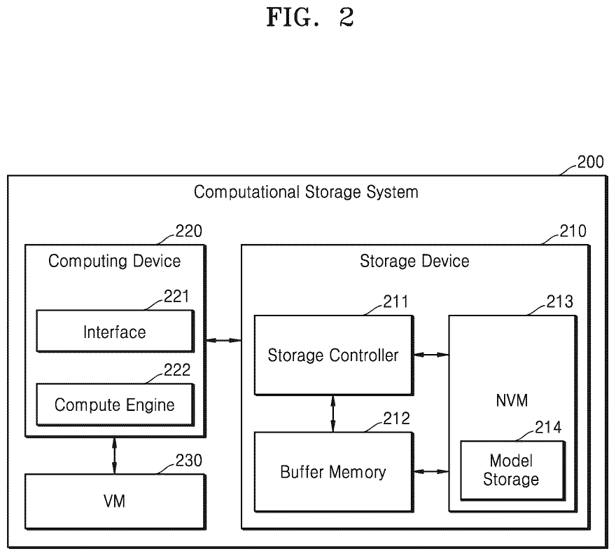

The storage device 210 may store data that is provided by the host device 100. In some implementations, the storage device 210 stores base data, an event table, and a neural network model, which are generated by the computing device 220. In some implementations, the storage device 210 stores original video data (or at least a portion of the original video data) and/or inference video data (or at least a portion of the inference video data) that is generated by the computing device 220. A detailed configuration and operations of the storage device 210 are described below in more detail with reference to FIG. 2 and subsequent figures.

The computing device 220, which is a device for performing data processing on received data, may perform data processing in response to a data processing request received from the host device 100. For example, the computing device 220 may perform data processing on input data by running an application. The application may include a plurality of data operations related to performing a task, for example, an arithmetic operation, a convolution operation, a polling operation, and the like. For example, when the computing device 220 performs a task that is based on a neural network, the application may include a neural network model. The neural network model may include a plurality of data operations, which are based on at least one of a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a transformer, a fully convolutional network, a long short-term memory (LSTM) network, a classification network, and various neural networks, and the neural network model may perform the plurality of data operations and operations regarding to input and output sizes, weights, biases, and the like of the plurality of data operations. For example, the neural network model, which is a generative model, may include a deep-fake model.

For example, the computing device 220 may be implemented by a graphics processing unit (GPU), a digital signal processor (DSP), a field programmable gate array (FPGA), an application-specific integrated circuit (ASIC), a neural processing unit (NPU), or the like. However, the scope of this disclosure is not limited thereto, and the computing device 220 may be implemented by, for example, various acceleration circuits (accelerators) configured to perform data processing, for example, data operations, required to perform an allocated task, in parallel.

In some implementations, the computing device 220 generates inference video data corresponding to original video data, based on the base data and an event table, by using a neural network model, in response to an inference video generation request received from the host device 100 (or in response to the input of the original video data to the computational storage system 200). For example, the computing device 220 may generate, by using a neural network model for each of at least one region, inference video data for each of the at least one region, which corresponds to each neural network model (where the at least one region refers to a region (for example, a person region, a background region, or the like in the original video data (a CCTV-captured video) that is included in the original video data). For example, the computing device 220 may generate, by using a neural network model for each of at least one section, inference video data for each of the at least one section, which corresponds to each neural network model (where the at least one section refers to a section (for example, a straight driving section, a corner driving section, an intersection driving section, or the like in the original video data (a black box-captured video) that is included in the original video data).

In some implementations, the computing device 220 detects/identifies an abnormal access by identifying a security code of the abnormal access or by identifying a data pattern or a command type of a data request from the abnormal access. When an abnormal access to the computational storage system 200 (or the storage device 210) is detected/identified, the computing device 220 may generate fake inference video data based on a security level of the abnormal access.

In some implementations, the computing device 220 generates at least one sub-neural network model by subdividing a neural network model, in response to a neural network model subdivision request (or in response to the input of the original video data to the computational storage system 200). A detailed configuration and operations of the computing device 220 are described in more detail with reference to FIG. 2 and subsequent figures.

The volatile memory 230 may store data used for data processing by the computing device 220. The volatile memory 230 may store data generated by the computing device 220 or data generated as a result of data processing by the computing device 220. Here, when the computing device 220 performs data processing based on data stored in the storage device 210, the data (for example, base data, an event table, a neural network model, at least one sub-neural network model generated by subdividing the neural network model, or the like) stored in the storage device 210 may be read and stored in the volatile memory 230.

The volatile memory 230 may be implemented by volatile memory, such as dynamic random-access memory (DRAM), static RAM (SRAM), or the like.

FIG. 2 is a block diagram illustrating a computational storage system according to some implementations. Referring to FIG. 2, the computational storage system 200 may include a storage device 210, a computing device 220, and volatile memory (which may be alternatively referred to as “VM”) 230.

The computing device 220 may include an interface 221 and a compute engine 222.

The interface 221 may be arranged in the computational storage system 200 to manage the transmission of requests, data, or the like between the host device 100 and the compute engine 222 in the computing device 220. In addition, the interface 221 may be arranged in the computational storage system 200 to manage the transmission of requests, data, or the like between the host device 100 and the storage device 210.

The interface 221 may receive a data processing request or an inference video generation request from the host device 100. The data processing request may be a request for the computing device 220 to perform data processing on data already stored in the storage device 210 or on data received from the host device 100. When the data processing request is received from the host device 100, the interface 221 may transmit the data processing request to the compute engine 222. Therefore, data processing corresponding to the data processing request may be performed by the compute engine 222 of the computing device 220.

In some implementations, the interface 221 may receive an inference video generation request from the host device 100. The inference video generation request may be a request for the computing device 220 to generate inference video data corresponding to original video data by using a neural network model and store the inference video data in the storage device 210. When the inference video generation request is received from the host device 100, the interface 221 may transmit the inference video generation request to the compute engine 222. Therefore, the inference video data may be generated by the compute engine 222 of the computing device 220, based on base data and an event table.

In some implementations, when original video data is input to the computational storage system 200 (or when the original video data is generated) (even though the inference video generation request is not received from the host device 100), the computational storage system 200 generates inference video data via the compute engine 222, based on base data and an event table. That is, in response to the input of the original video data to the computational storage system 200 (or in response to the generation of the original video data), the compute engine 222 of the computing device 220 may generate the inference video data by using a neural network model for each corresponding region (or for each corresponding section).

In some implementations, the compute engine 222 of the computing device 220 adjusts a generation rate of the inference video data according to the performance of the compute engine 222. For example, the compute engine 222 may slowly generate the inference video data, as a background process, according to the performance of the compute engine 222. As another example, in response to the reception of the inference video generation request from the host device 100 (or in response to the input of the original video data), the compute engine 222 may quickly generate the inference video data in real-time, according to the performance of the compute engine 222.

In some implementations, the interface 221 receives, from the host device 100, a request for generation of fake inference video data. When the request for generation of fake inference video data is received from the host device 100, the interface 221 may transmit the request for generation of fake inference video data to the compute engine 222. Therefore, fake inference video data may be generated by the compute engine 222 of the computing device 220.

In some implementations, the interface 221 may receive security code from an abnormal access. When the security code is received from the abnormal access, the interface 221 may transmit the security code to the compute engine 222. For example, the interface 221 may transmit first security code to the compute engine 222 when the abnormal access is caused by the leakage of authentication on a website, may transmit second security code to the compute engine 222 when the abnormal access is caused by the leakage of hardware, and may transmit third security code to the compute engine 222 when the abnormal access is caused by the leakage of authentication on a network. Therefore, the fake inference video data may be generated by the compute engine 222 of the computing device 220.

In some implementations, the interface 221 transmits a data pattern of the abnormal access or a command of the abnormal access to the compute engine 222. Therefore, the fake inference video data may be generated by the compute engine 222 of the computing device 220.

In some implementations, when a neural network model subdivision request is received from the host device 100, the interface 221 transmits the neural network model subdivision request to the compute engine 222. Therefore, at least one sub-neural network model may be generated by the compute engine 222 of the computing device 220. The neural network model subdivision request may be a request for the computing device 220 to generate at least one sub-neural network model by subdividing a neural network model and store the at least one sub-neural network model in the storage device 210 (for example, a model storage 214).

In some implementations, when the original video data is input to the computational storage system 200 (or when the original video data is generated) (even though the neural network model subdivision request is not received from the host device 100), the computational storage system 200 generates at least one sub-neural network model by subdividing a neural network model via the compute engine 222.

In some implementations, the interface 221 receives a neural network model read request from the host device 100. The neural network model read request may be a request to read a neural network model stored in the storage device 210. When the neural network model read request is received from the host device 100, the interface 221 may transmit the neural network model read request to the storage device 210. Therefore, a neural network model may be read from nonvolatile memory 213 of the storage device 210 and transmitted to the host device 100.

The compute engine 222 may perform data processing in response to a data processing request. In response to the data processing request, the compute engine 222 may perform data processing on data already stored in the storage device 210 or on data received from the host device 100. The compute engine 222 may store, in a register inside thereof, a value computed in the process of data processing. In addition, the compute engine 222 may store, in the volatile memory 230, data generated in the process of data processing and data generated as a result of data processing. The compute engine 222 may store, in the storage device 210 via the interface 221, the data generated as a result of data processing.

In some implementations, the compute engine 222 generates a neural network model for generating inference video data (corresponding to original video data), based on base data and an event table. For example, the compute engine 222 may generate at least one neural network model respectively corresponding to at least one region in the original video data. As another example, the compute engine 222 may generate at least one neural network model respectively corresponding to at least one section in the original video data.

In some implementations, in response to an inference video generation request, the compute engine 222 generates inference video data based on base data and an event table, by using a neural network model. Here, the base data may refer to basic raw data of at least one object that is included in the original video data, and the event table may refer to data in which events having occurred in the base data are respectively mapped to generation times of the events.

The inference video data may be video data generated by the compute engine 222 (or the neural network model), based on features of each region or each section of the original video data (for example, base data and events for each region or each section of the original video data). That is, in response to the inference video generation request, the compute engine 222 may generate the inference video data by using a neural network model and, when a matching ratio between the original video data and the inference video data is equal to or greater than a preset threshold (for example, 80%), may store the base data, the event table, and the neural network model (low-volume data) instead of storing the original video data (high-volume data).

In some implementations, the compute engine 222 divides the original video data into at least one region (or at least one section), based on whether the data size of the event table in the original video data increases to a preset size or more.

In some implementations, the compute engine 222 generates, by using a neural network model for each of the at least one region, inference video data for each of the at least one region, which corresponds to each neural network model.

In some implementations, the compute engine 222 generates, by using a neural network model for each of the at least one section, inference video data for each of the at least one section, which corresponds to each neural network model.

In some implementations, after the inference video data is generated, when the matching ratio between the original video data and the inference video data is equal to or greater than the preset threshold (for example, 80%), the compute engine 222 generates a request to store the base data, the event table, and the neural network model, which form a basis for the generation of the inference video data, by using an access protocol shared from a storage controller 211 (in this case, the original video data may be deleted).

In some implementations, after the inference video data is generated, when the matching ratio between the original video data and the inference video data is less than the preset threshold (for example, 80%) (and when an increasing rate of the matching ratio is also less than a threshold (for example, 2%), the compute engine 222 generates a request to store the original video data, by using the access protocol shared from the storage controller 211 (in this case, the base data, the event table, and the neural network model may be deleted).

In some implementations, after the inference video data is generated, when the matching ratio between the original video data and the inference video data is less than the preset threshold (for example, 80%), the compute engine 222 regenerates the neural network model based on the base data and the event table. The compute engine 222 may regenerate the inference video data by using the regenerated neural network model. When the matching ratio between the original video data and the regenerated inference video data is equal to or greater than the preset threshold (for example, 80%), the compute engine 222 may generate a request to store the base data, the event table, and the neural network model, which form a basis for the generation of the inference video data, by using the access protocol shared from the storage controller 211.

The request, generated by the compute engine 222, to store the base data, the event table, and the neural network model or to store the original video data may be transmitted to the storage device 210 via the interface 221. The computational storage system 200 according to some implementations may store the original video data, may store the base data, the event table, and the neural network model, or may store the original video data together with the base data, the event table, and the neural network model, depending on setting options.

In some implementations, when the number of uses of a particular neural network model from among a plurality of neural network models in the process of generating the inference video data increases to a threshold or more, the compute engine 222 generates at least one first sub-neural network model by subdividing the particular neural network model and may store the at least one first sub-neural network model in the storage device 210 (for example, the model storage 214). The compute engine 222 may generate at least a portion of first target inference video data based on the at least one first sub-neural network model. Here, the first target inference video data may refer to inference video data generated by the particular neural network model.

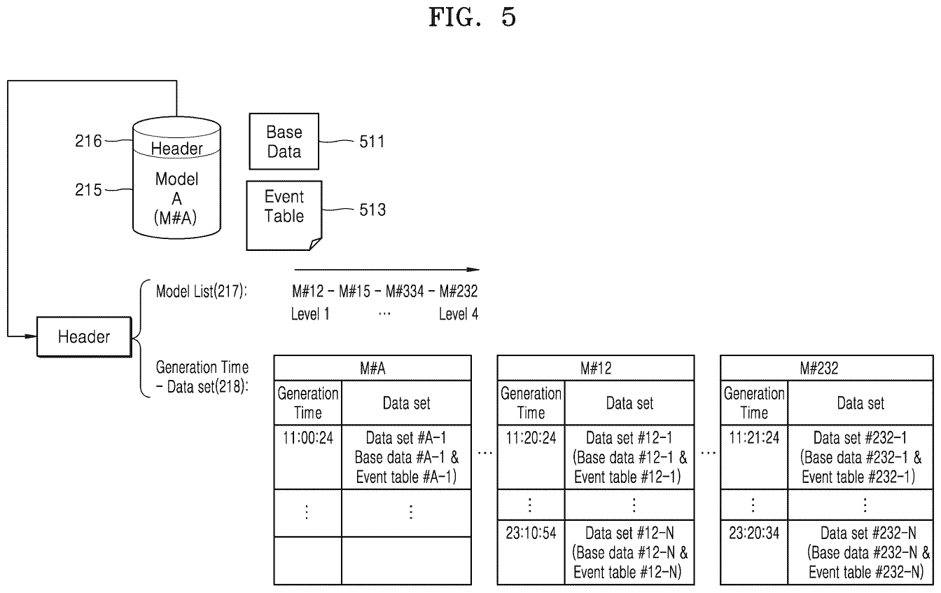

In some implementations, the compute engine 222 compares, with each other, matching ratios between inference video data generated by the at least one first sub-neural network model and inference video data generated by each of the plurality of neural network models (or a plurality of sub-neural network models). The compute engine 222 may generate a model list by making up a list of the plurality of neural network models (or the plurality of sub-neural network models) in order of matching ratios, from highest to lowest, based on a comparison result. The compute engine 222 may store the model list in a header of each neural network model. Here, the header of each neural network model may include a generation time-data set of each neural network model, the model list, and a generation time-data set of each of at least one neural network model in the model list. This is described below in detail with reference to FIG. 5. Hereinafter, the “time-data set” may be also referred to as “time-associated base data”.

In some implementations, when there is a first alternative neural network model #1 that generates inference video data having a matching ratio equal to or greater than a threshold as compared with the inference video data generated by the at least one first sub-neural network model, the compute engine 222 deletes the at least one first sub-neural network model and may link the first alternative neural network model #1 to the particular neural network model. The compute engine 222 may generate at least a portion of the first target inference video data based on the first alternative neural network model #1.

In some implementations, when the number of uses of a particular sub-neural network model out of the at least one first sub-neural network model in the process of generating the inference video data increases to a threshold or more, the compute engine 222 generates at least one second sub-neural network model by subdividing the particular sub-neural network model and may store the at least one second sub-neural network model in the storage device 210 (for example, the model storage 214). The compute engine 222 may generate at least a portion of second target inference video data based on the at least one second sub-neural network model. Here, the second target inference video data may refer to inference video data generated by the particular sub-neural network model.

In some implementations, when there is a second alternative neural network model #2 that generates inference video data having a matching ratio equal to or greater than a second threshold as compared with the inference video data generated by the at least one second sub-neural network model, the compute engine 222 deletes the least one second sub-neural network model and may link the second alternative neural network model #2 to a target sub-neural network model. The compute engine 222 may generate at least a portion of the second target inference video data based on the second alternative neural network model #2.

In some implementations, until the total data size obtained by summing up data sizes of the plurality of neural network models and the data size of the at least one sub-neural network model (for example, the at least one first sub-neural network model and the at least one second sub-neural network model) reaches a data size allocated to the model storage 214, the compute engine 222 generates at least one sub-neural network model (for example, the at least one first sub-neural network model and/or the at least one second sub-neural network model) by subdividing the particular neural network model.

In some implementations, when there is a need to re-subdivide the particular neural network model (that is, when there is a need to generate a new sub-neural network model because new original video data is input to the computational storage system 200), the compute engine 222 deletes some sub-neural network models (for example, the at least one first sub-neural network model and/or the at least one second sub-neural network model) for which the number of uses thereof is less than a threshold, out of the at least one first sub-neural network model (or the at least one second sub-neural network model), and may re-subdivide the particular neural network model, thereby generating a new sub-neural network model (for example, the at least one first sub-neural network model and/or the at least one second sub-neural network model).

In some implementations, during the process of generating the inference video data, when the number of uses of some sub-neural network models out of the at least one first sub-neural network model and the at least one second sub-neural network model decreases to be less than a third threshold due to an increase in the number of uses of the second alternative neural network model, the compute engine 222 deletes the sub-neural network models (for example, the at least one first sub-neural network model and/or the at least one second sub-neural network model) and may link a target neural network model (or a target sub-neural network model) to the second alternative neural network model. The compute engine 222 may generate at least a portion of the first target inference video data (or the second target inference video data) based on the second alternative neural network model. The compute engine 222 may re-subdivide the target neural network model (or the target sub-neural network model) while deleting the sub-neural network models (for example, the at least one first sub-neural network model and/or the at least one second sub-neural network model).

In some implementations, the compute engine 222 generates and outputs fake inference video data based on a security level of an abnormal access, in response to a request to generate the fake inference video data. Here, the security level may indicate a data leakage path of the abnormal access. In some implementations, the security level (for example, a first security level (that is, Level 1)) may further include subdivided security levels (for example, a 1st-1 security level (that is, Level 1-1), a 1st-2 security level (that is, Level 1-2), . . . , and a 1st-N security level (that is, Level 1-N)) according to a use environment of the computational storage system 200 or a selection by a user.

In some implementations, the compute engine 222 generates and outputs the fake inference video data based on the security level of the abnormal access, in response to receiving security code from the abnormal access.

In some implementations, the compute engine 222 generates and outputs the fake inference video data based on the security level of the abnormal access, in response to identifying a data pattern of the abnormal access or a command (for example, a command type) of the abnormal access.

In some implementations, the compute engine 222 selects an alternative neural network model and an alternative generation time-data set based on the security level of the abnormal access and may generate and output the fake inference video data based on the alternative neural network model and the alternative generation time-data set that are selected.

In some implementations, when there is no generation time-data set corresponding to the security level of the abnormal access, the compute engine 222 reselects the alternative neural network model based on the model list of the target neural network model. Here, the target neural network model may refer to a neural network model for generating data for which a request (for example, a read request) is made by the abnormal access, among the plurality of neural network models stored in the storage device 210.

The storage device 210 may include a storage controller 211, a buffer memory 212, and a nonvolatile memory 213.

The storage controller 211 may manage operations of the storage device 210 and may control the nonvolatile memory 213 to perform an operation according to a request received from the host device 100. For example, in response to a write or read request from the host device 100, the storage controller 211 may control the nonvolatile memory 213 such that data is written to or read from the nonvolatile memory 213, and may control an erase operation of the nonvolatile memory 213. In addition, the storage controller 211 may manage main operations of the nonvolatile memory 213, such as garbage collection, bad block management, read reclaim, and read replacement, and may manage the power of the nonvolatile memory 213.

The buffer memory 212 may operate, in the storage device 210, as a buffer for temporarily storing data. The buffer memory 212 may store data received from the host device 100 or read from the nonvolatile memory 213. In addition, the buffer memory 212 may store data generated by the computing device 220.

The buffer memory 212 may be implemented by volatile memory, such as DRAM or SRAM. However, the inventive concept is not limited thereto, and the buffer memory 212 may be implemented by various types of nonvolatile memory including resistive nonvolatile memory, such as magnetic RAM (MRAM), phase-change RAM (PRAM), or resistive RAM (ReRAM), flash memory, nano-floating gate memory (NFGM), polymer RAM (PoRAM), or ferroelectric RAM (FRAM). Although the buffer memory 212 is illustrated in the present embodiment as being arranged outside the storage controller 211, the buffer memory 212 is not limited thereto, and the buffer memory 212 may be arranged inside the storage controller 211.

The nonvolatile memory 213 may store data. The nonvolatile memory 213 may store data provided from the host device 100 or the computing device 220. The nonvolatile memory 213 may include a memory cell array including nonvolatile memory cells capable of maintaining stored data, even when the power of the storage device 210 is cut-off, and the memory cell array may be divided into a plurality of memory blocks. The plurality of memory blocks may have a 2-dimensional horizontal structure, in which memory cells are 2-dimensionally arranged on the same plane (or layer), or a 3-dimensional vertical structure, in which nonvolatile memory cells are 3-dimensionally arranged. A memory cell may be a single-level cell (SLC) storing one bit of data or a multi-level cell (MLC) storing two or more bits of data. However, the memory cells are not limited thereto, and each memory cell may be a triple-level cell (TLC) storing 3-bit data or a quadruple-level cell storing 4-bit data.

The nonvolatile memory 213 may include a plurality of dies or a plurality of chips, which each include a memory cell array (MCA). For example, the nonvolatile memory 213 may include a plurality of chips, and each of the plurality of chips may include a plurality of dies. In some implementations, the nonvolatile memory 213 includes a plurality of channels each including a plurality of chips.

The nonvolatile memory 213 may include a NAND flash memory device. However, the nonvolatile memory 213 is not limited thereto, and the nonvolatile memory 213 may be implemented by resistive memory devices, such as ReRAM, PRAM, and MRAM.

In some implementations, the storage controller 211 receives a request to store base data, an event table, and a neural network model as well as the base data, the event table, and the neural network model from the interface 221 of the computing device 220 by using an access protocol. The storage controller 211 may store the base data, the event table, and the neural network model in the nonvolatile memory 213, in response to the request to store the base data, the event table, and the neural network model, the request being received from the computing device 220 by using the access protocol.

In some implementations, the storage controller 211 receives a request to store original video data as well as the original video data from the interface 221 of the computing device 220 by using the access protocol. The storage controller 211 may store the original video data in the nonvolatile memory 213, in response to the request to store the original video data, the request being received from the computing device 220 by using the access protocol.

In some implementations, the storage controller 211 receives at least one sub-neural network model from the interface 221 of the computing device 220 by using the access protocol, the at least one sub-neural network model being generated by subdividing a neural network model. The storage controller 211 may store the at least one sub-neural network model in the nonvolatile memory 213 (for example, the model storage 214), in response to a model subdivision request received from the computing device 220 by using the access protocol.

In some implementations, the storage controller 211 receives the fake inference video data, which is generated based on the security level of the abnormal access, from the interface 221 of the computing device 220 by using the access protocol. The storage controller 211 may store the fake inference video data in the nonvolatile memory 213, in response to a request to generate the fake inference video data, the request being received from the computing device 220 by using the access protocol.

In some implementations, in the above descriptions made with reference to FIGS. 1 and 2, one or more operations (or some components) of the computational storage system 200 are implemented as one or more operations (or components) of the host device 100.

For example, in some implementations, in response to receiving a request from a user or the generation of the original video data, the host device 100 generates base data and an event table corresponding thereto from the original video data. The host device 100 may generate a neural network model for each of at least one region (or for each of at least one section), based on the base data and the event table for each of the at least one region (or for each of at least one section). In some implementations, when a request from a user is received or the original video data is input to the computational storage system 200, the computational storage system 200 receives the base data, the event table, and the neural network model for each region (or the base data, the event table, and the neural network model for each section) from the host device 100 and may generate inference video data for each region (or for each section), based on the base data, the event table, and the neural network model, which are received.

For example, in some implementations, when the number of uses of a target neural network model from among a plurality of neural network models increases to a threshold or more in the process of generating inference video data, the host device 100 generates at least one first sub-neural network model by subdividing the target neural network model and may store the at least one first sub-neural network model in the computational storage system 200 (for example, the storage device 210). Here, until the total data size of the plurality of neural network models and the at least one sub-neural network model reaches a data size allocated to the model storage 214, the host device 100 may generate the at least one first sub-neural network model by subdividing the target neural network model. In addition, the host device 100 may compare, with each other, matching ratios between the inference video data generated by the at least one first sub-neural network model and the inference video data generated by each of the plurality of neural network models, and thus, may generate a model list by making up a list of the plurality of neural network models in order of matching ratios, from highest to lowest. That is, the model list may refer to a list including at least one neural network model that generates inference video data similar to the inference video data generated by each of the plurality of neural network models. The host device 100 may store the model list corresponding to the at least one first sub-neural network model in a header of the at least one first sub-neural network model.

For example, in some implementations, when an abnormal access to the computational storage system 200 (or the storage device 210) is identified, the host device 100 may generate and output fake inference video data by using an alternative neural network model and an alternative generation time-data set, which are selected based on a security level of the abnormal access.

As such, use of the computational storage system 200 allows the computing device 200 to generate inference video data corresponding to original video data by using base data and an event table as well as a neural network model. Therefore, the computational storage system 200 according to some implementations may store the neural network model, the base data, and the event table, which have relatively small data sizes, instead of storing the original video data having a large data size, and thus, the storage device 210 may be efficiently managed by maximizing the utilization of a storage space in the storage device 210.

In addition, when an abnormal access by an intruder is identified/detected, the computational storage system 200 according to some implementations may generate fake inference video data by using an alternative neural network model and an alternative generation time-data set, which are selected based on a security level of the abnormal access, and thus, the security of data may be enhanced by preventing the leakage of the data stored in a storage device.

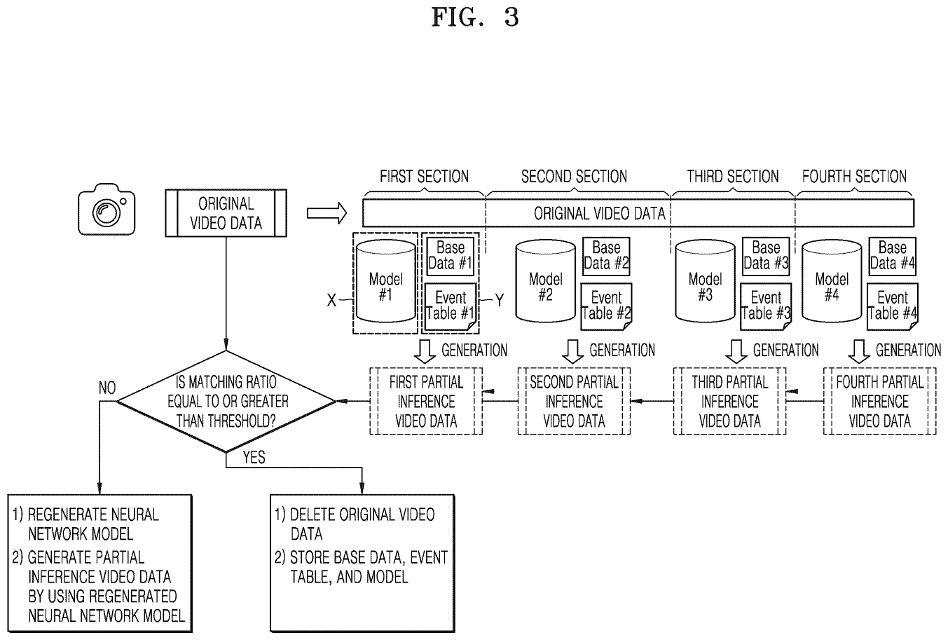

FIG. 3 is a diagram illustrating operations of a computational storage system, according to some implementations.

In detail, FIG. 3 is a diagram illustrating an operation, performed by the computing device 220 of the computational storage system 200, of generating at least one neural network model by dividing original video data into at least one section (or at least one region) and an operation, performed by the computing device 220 of the computational storage system 200, of comparing, with each other, matching ratios between the original video data and inference video data generated by the at least one neural network model.

Referring to FIG. 3, in some implementations, the computing device 220 of the computational storage system 200 receives, from an external device (for example, the host device 100), original video data taken by using an imaging device (for example, a camera).

In some implementations, the computing device 220 divides the original video data into at least one section (or at least one region) based on whether the data size of an event table increases to a threshold (for example, 200%) or more. For example, the computing device 220 may divide the original video data into first to fourth sections (or first to fourth regions (not shown)) based on whether the data size of the event table in the original video data increases to the threshold (for example, 200%) or more.

In some implementations, the computing device 220 generates a neural network model of each section, based on base data and an event table, which correspond to each of the sections (or the regions). For example, the computing device 220 may generate a first neural network model (that is, Model #1) corresponding to the first section (or the first region), based on first base data (that is, Base data #1) and a first event table (that is, Event table #1) of the first section (or the first region). For example, the computing device 220 may generate a second neural network model (that is, Model #2) corresponding to the second section (or the second region), based on second base data (that is, Base data #2) and a second event table (that is, Event table #2) of the second section (or the second region). For example, the computing device 220 may generate a third neural network model (that is, Model #3) corresponding to the third section (or the third region), based on third base data (that is, Base data #3) and a third event table (that is, Event table #3) of the third section (or the third region). For example, the computing device 220 may generate a fourth neural network model (that is, Model #4) corresponding to the fourth section (or the fourth region), based on fourth base data (that is, Base data #4) and a fourth event table (that is, Event table #4) of the fourth section (or the fourth region).

In some implementations, the computing device 220 generates inference video data for each section by using the neural network model corresponding to each of the sections (or the regions). For example, the computing device 220 may generate first partial inference video data corresponding to the first section (or the first region), based on the first base data (that is, Base data #1) and the first event table (that is, Event table #1) of the first section (or the first region), by using the first neural network model (that is, Model #1). For example, the computing device 220 may generate second partial inference video data corresponding to the second section (or the second region), based on the second base data (that is, Base data #2) and the second event table (that is, Event table #2) of the second section (or the second region), by using the second neural network model (that is, Model #2). For example, the computing device 220 may generate third partial inference video data corresponding to the third section (or the third region), based on the third base data (that is, Base data #3) and the third event table (that is, Event table #3) of the third section (or the third region), by using the third neural network model (that is, Model #3). For example, the computing device 220 may generate fourth partial inference video data corresponding to the fourth section (or the fourth region), based on the fourth base data (that is, Base data #4) and the fourth event table (that is, Event table #4) of the fourth section (or the fourth region), by using the fourth neural network model (that is, Model #4).

In some implementations, the computing device 220 calculates a matching ratio between the original video data and each piece of partial inference video data and may identify whether the matching ratio is equal to or greater than a threshold (for example, 80%). Here, the matching ratio may indicate the degree of matching between the original video data and each piece of partial inference video data, based on features (for example, a change in an object, the concentration and color change of the object, and the like) of video data.

In some implementations, when the matching ratio is equal to or greater than the threshold (for example, 80%), the computing device 220 deletes the original video data and may store, in the storage device 210, the base data, the event table, and the neural network model of the corresponding section instead of the original video data.

In some implementations, when the matching ratio is less than the threshold (for example, 80%), the computing device 220 regenerates the neural network model of the corresponding section. For example, the computing device 220 may regenerate the neural network model by resetting the section of the original video data (that is, by changing the base data and the event table). The computing device 220 may generate partial inference video data by using the regenerated neural network model.

As described above, the computational storage system 200 (or the computing device 220) according to some implementations may calculate a matching ratio indicating the degree of matching between the original video data and an inference video data and, when the matching ratio is less than the threshold (for example, 80%), may regenerate the neural network model based on the base data and the event table (that is, may retrain the neural network model based on the base data and the event table).

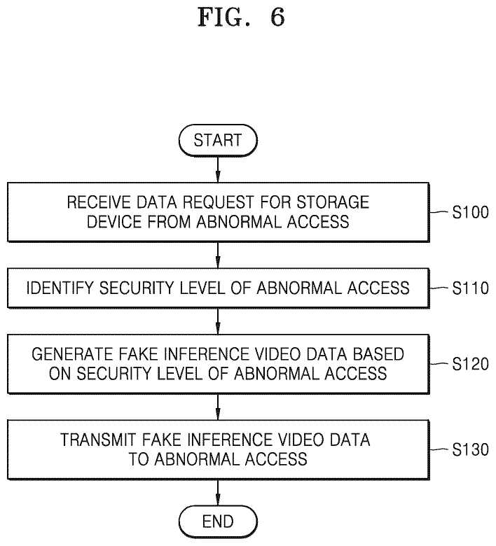

In some implementations, when an abnormal access (for example, a data read request by an intruder, or the like) to particular data (for example, data of the first section) stored in the computational storage system 200 (or the storage device 210) is identified, the computing device 220 may generate and output fake inference video data based on an alternative neural network model and an alternative generation time-data set, which are selected based on a security level of the abnormal access. For example, when an abnormal access to the data of the first section (or the first region) of the original video data is identified, the computing device 220 may select an alternative neural network model for generating inference video data (that is, fake inference video data) of the first section (or the first region) in place of a target neural network model (for example, the first neural network model (that is, Model #1)) X. In addition, the computing device 220 may select the alternative generation time-data set, which is to be used when the inference video data (that is, the fake inference video data) of the first section (or the first region) is generated by the alternative neural network model, in place of a data set (for example, the first base data (that is, Base data #1) and the first event table (that is, Event table #1) at each time) Y of the target neural network model (for example, the first neural network model (that is, Model #1)) X. The computing device 220 may generate and output the fake inference video data based on the alternative neural network model and the alternative generation time-data set, thereby preventing data leakage due to the abnormal access. This is described below in more detail with reference to FIGS. 6 to 10C.

Although an operation of generating inference video data based on a neural network model for each of at least one section (for example, the first to fourth sections) is illustrated in FIG. 3 for convenience of description, the scope of this disclosure is not limited thereto, and the computational storage system 200 (or the computing device 220) according to some implementations may generate inference video data based on a neural network model for each of at least one region (for example, the first to fourth regions).

Therefore, the computational storage system 200 according to some implementations may store base data, an event table, and a neural network model (low volume) instead of original video data (high volume), thereby improving the efficiency of a storage space of a memory 230.

In addition, when an abnormal access by an intruder is identified, the computational storage system 200 according to some implementations may output fake inference video data, thereby preventing data stored in a storage device from being leaked by the abnormal access.

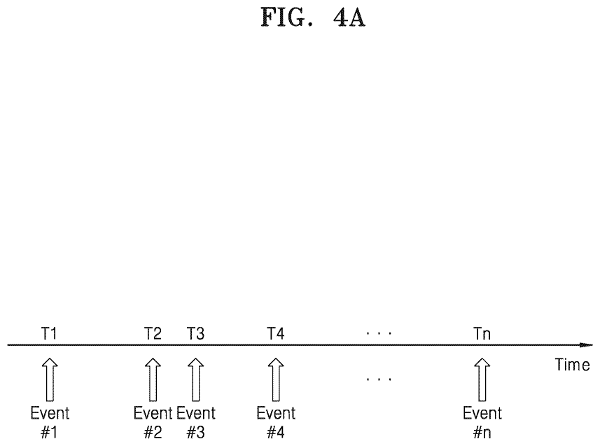

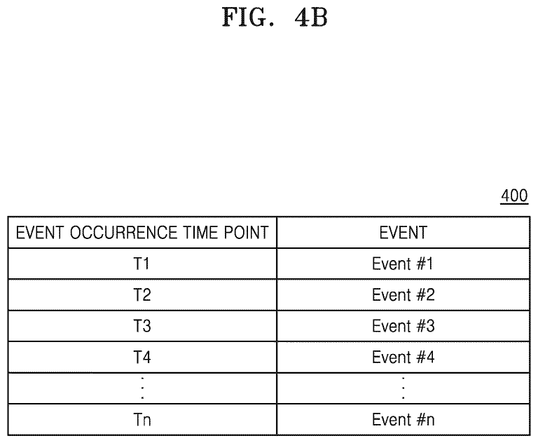

FIG. 4A is a diagram illustrating operations of a computational storage system, according to some implementations. FIG. 4B illustrates an example of an event table of a computational storage system, according to some implementations.

In detail, FIG. 4A is a diagram illustrating an operation, performed by the computing device 220 of the computational storage system 200, of generating an event table, and FIG. 4B illustrates an example of an event table 400 generated by the computing device 220 in FIG. 4A.

Referring to FIG. 4A, a time line is illustrated to enumerate, in order of occurrence time, a plurality of events (for example, the movement of an object (or a change in position coordinates of the object), a motion change, a weather change (e.g., an illuminance change, a meteorological change, or a precipitation change), the appearance of a new object, a change in color/tone of an object, and the like) having occurred in base data that is included in at least one region/section of original video data. For example, a first event (that is, Event #1) may occur at a first time point T1, a second event (that is, Event #2) may occur at a second time point T2, a third event (that is, Event #3) may occur at a third time point T3, a fourth event (that is, Event #4) may occur at a fourth time point T4, . . . , and an n-th event (that is, Event #n) may occur at an n-th time point Tn.

Referring to FIGS. 4A and 4B, the computing device 220 may generate the event table 400 by mapping each of the plurality of events to the occurrence time thereof. For example, the computing device 220 may map the first event (that is, Event #1) to the first time point T1 that is the occurrence time of the first event (that is, Event #1), may map the second event (that is, Event #2) to the second time point T2 that is the occurrence time of the second event (that is, Event #2), may map the third event (that is, Event #3) to the third time point T3 that is the occurrence time of the third event (that is, Event #3), may map the fourth event (that is, Event #4) to the fourth time point T4 that is the occurrence time of the fourth time point T4, . . . , and may map the n-th event (that is, Event #n) to the n-th time point Tn that is the occurrence time of the -th event (that is, Event #n), thereby generating the event table 400.

FIG. 5 illustrates an example of a neural network model structure according to some implementations.

In detail, FIG. 5 is a diagram illustrating a header of a neural network model, the header being a portion of the neural network model structure. In FIG. 5, a target neural network model is assumed to be a neural network model A (that is, M #A) 215.

Referring to FIG. 5, the computational storage system 200 (or the storage device 210) according to some implementations may store the neural network model A (that is, M #A) 215, and base data 511 and an event table 513 both corresponding to the neural network model A (that is, M #A) 215. Here, the base data 511 may refer to basic raw data of at least one object in the original video data, and the event table 513 may refer to data obtained by mapping events having occurred in the base data to respective occurrence times of the events.

In some implementations, the neural network model A (that is, M #A) 215, may include a header 216. Although FIG. 5 illustrates that the header 216 of the neural network model A (that is, M #A) 215 is included in the front end of the neural network model A (that is, M #A) 215, the data structure is not limited thereto, and a header (for example, 216) of a neural network model according to some implementations may be included in various positions in the neural network model.

In some implementations, the header 216 of the neural network model A (that is, M #A) 215 includes a model list 217 and a generation time-data set 218 of the neural network model A (that is, M #A) 215.

In some implementations, the model list 217 may refer to a list including neural network models that generate inference video data similar to inference video data generated by the neural network model A (that is, M #A) 215. For example, the computing device 220 of the computational storage system 200 may compare, with each other, matching ratios between the inference video data generated by the neural network model A (that is, M #A) 215 and inference video data generated by each of the plurality of neural network models (or a plurality of sub-neural network models) stored in the storage device 210. The computing device 220 may generate a model list of the neural network model A (that is, M #A) 215 by making up a list of the plurality of neural network models (or the plurality of sub-neural network models) in order of matching ratios, from highest to lowest. For example, the model list of the neural network model A (that is, M #A) 215 may be “M #12-M #15-M #334-M #232”. That is, the inference video data generated by the neural network model 12 (that is, M #12) is most similar to the inference video data generated by the neural network model A (that is, M #A) 215, and the inference video data generated by the neural network model 232 (that is, M #232) may be most dissimilar to the inference video data generated by the neural network model A (that is, M #A) 215.

In some implementations, at least one neural network model (for example, the neural network model 12 (that is, M #12), the neural network model 15 (that is, M #15), the neural network model 334 (that is, M #334), and the neural network model 232 (that is, M #232)) in the model list 217 may be stored while respectively mapped to different security levels according to a use environment of the computational storage system 200 or a selection by a user. For example, the neural network model 12 (that is, M #12) may be mapped to a first security level (that is, Level 1) and stored, and the neural network model 232 (that is, M #232) may be mapped to a fourth security level (that is, Level 4) and stored. However, the scope of the present disclosure is not limited thereto, and according to a use environment of the computational storage system 200 or a selection by a user, the neural network model 12 (that is, M #12) may be mapped to the fourth security level (that is, Level 4) and stored and the neural network model 232 (that is, M #232) may be mapped to the first security level (that is, Level 1) and stored.

In some implementations, the generation time-data set 218 includes a generation time-data set of the neural network model A (that is, M #A) 215, which is a target neural network model, and a generation time-data set of each of the at least one neural network model (for example, the neural network model 12 (that is, M #12) to the neural network model 232 (that is, M #232)) in the model list 217. Here, the generation time-data set 218 may include generation time, and a data set for base data and an event table both corresponding to the generation time. Herein, the generation time means the generation time of the original video data corresponding to the inference video data generated by each of the neural network models (for example, the neural network model A (that is, M #A) 215, the neural network model 12 (that is, M #12), . . . , or the neural network model 232 (that is, M #232)). For example, the generation time-data set of the neural network model A (that is, M #A) 215 may include A^{th}-1 generation time (that is, 11:00:24) and an A^{th}-1 data set (for example, A^{th}-1 base data (that is, Base data #A-1) and an A^{th}-1 event table (that is, Event table #A-1)) corresponding to the A^{th}-1 generation time (that is, 11:00:24). The neural network model A (that is, M #A) 215 may generate inference video data of the A^{th}-1 generation time (that is, 11:00:24) based on the A^{th}-1 data set (for example, the A^{th}-1 base data (that is, Base data #A-1) and the A^{th}-1 event table (that is, Event table #A-1)). The generation time-data set of the neural network model 12 (that is, M #12) may include 12^{th}-1 generation time (that is, 11:20:24) and a 12^{th}-1 data set (for example, 12^{th}-1 base data (that is, Base data #12-1) and a 12^{th}-1 event table (that is, Event table #12-1)) corresponding to the 12^{th}-1 generation time (that is, 11:20:24). The neural network model 12 (that is, M #12) may generate inference video data of the 12^{th}-1 generation time (that is, 11:20:24) based on the 12^{th}-1 data set (for example, the 12^{th}-1 base data (that is, Base data #12-1) and the 12^{th}-1 event table (that is, Event table #12-1)). The generation time-data set of the neural network model 12 (that is, M #12) may include 12-N-th generation time (that is, 23:10:54) and a 12-N-th data set (for example, 12-N-th base data (that is, Base data #12-N) and a 12-N-th event table (that is, Event table #12-N)) corresponding to the 12-N-th generation time (that is, 23:10:54). The neural network model 12 (that is, M #12) may generate inference video data of the 12^{th}-N generation time (that is, 23:10:54) based on the 12^{th}-N data set (for example, the 12^{th}-N base data (that is, Base data #12-N) and the 12^{th}-N event table (that is, Event table #12-N)). The generation time-data set of the neural network model 232 (that is, M #232) may include 232^{th}-1 generation time (that is, 11:21:24) and a 232^{th}-1 data set (for example, 232^{th}-1 base data (that is, Base data #232-1) and a 232^{th}-1 event table (that is, Event table #232-1)) corresponding to the 232^{th}-1 generation time (that is, 11:21:24). The neural network model 232 (that is, M #232) may generate inference video data of the 232^{th}-1 generation time (that is, 11:21:24) based on the 232^{th}-1 data set (for example, the 232^{th}-1 base data (that is, Base data #232-1) and the 232^{th}-1 event table (that is, Event table #232-1)). The generation time-data set of the neural network model 232 (that is, M #232) may include 232^{th}-N generation time (that is, 23:20:34) and a 232^{th}-N data set (for example, 232^{th}-N-base data (that is, Base data #232-N) and a 232^{th}-N event table (that is, Event table #232-N)) corresponding to the 232^{th}-N generation time (that is, 23:20:34). The neural network model 232 (that is, M #232) may generate inference video data of the 232^{th}-N generation time (that is, 23:20:34) based on the 232^{th}-N data set (for example, the 232^{th}-N base data (that is, Base data #232-N) and the 232^{th}-N event table (that is, Event table #232-N)).

Each neural network model may include data sets respectively corresponding to one or more generation times.

As described above, the computational storage system 200 (or the computing device 220) according to some implementations may select an alternative neural network model and an alternative generation time-data set for generating fake inference video data, based on a model list (for example, 217) and a generation time-data set (for example, 218), which are included in a header (for example, 216) of each neural network model. This is described below in detail with reference to FIGS. 6 to 11C.

FIG. 6 is a flowchart illustrating an operation method of a computational storage system, according to some implementations.

Referring to FIG. 6, when an abnormal access is identified/detected by the computational storage system 200, a method, performed by the computational storage system 200, of generating fake inference video data may include operations S100 to S130. Regarding FIG. 6, repeated descriptions given with reference to FIGS. 1 to 5 are omitted. In FIG. 6, a target neural network model may refer to a neural network model that generates data (for example, inference video data) for which a request (for example, a read request) is made by an abnormal access, among a plurality of neural network models stored in the computational storage system 200 (or the storage device 210). Target generation time may refer to generation time of data (for example, video data) for which a request (for example, a read request) is made by an abnormal access. Hereinafter, the “time-data set” may be also referred to as “time-associated base data”.

In operation S100, the computational storage system 200 receives a data request from an abnormal access to the storage device 210 (or the computational storage system 200). For example, the computational storage system 200 may receive, from the abnormal access, a read request for data of the storage device 210.

In operation S100, the computational storage system 200 identifies a security level of the abnormal access. Here, the security level of the abnormal access may indicate a data leakage path of the abnormal access. The security level of the abnormal access may be determined based on a use environment of the computational storage system 200 or a selection by a user. For example, when the leakage of authentication data of a network is a fatal issue in the use environment of the computational storage system 200, the security level of the abnormal access due to the leakage of the authentication data of the network may be determined to be a first security level (that is, Level 1) that is the highest security level, and the security level of the abnormal access due to the leakage of data of hardware may be determined to be a fourth security level (that is, Level 4) that is the lowest security level.

In some implementations, the computational storage system 200 may identify the security level of the abnormal access based on a security code provided by the abnormal access. For example, when the host device 100 (see FIG. 1) suffers from attack (for example, hacking or the like) for an intruder to steal data of the storage device 210 (or the computational storage system 200), the host device 100 may provide a particular security code to the intruder. Here, the security code may be an authentication code used to make a data read request of the storage device 210 (or the computational storage system 200). Here, the particular security code provided by the host device 100 (see FIG. 1) may be an abnormal authentication code indicating an abnormal access by an intruder rather than normal authentication code. The intruder may transmit a data read request to the storage device 210 (or the computational storage system 200) through the abnormal access based on the particular security code provided by the host device 100 (see FIG. 1). When the data read request for the data of the storage device 210 is received from the abnormal access, the computational storage system 200 may identify the abnormal access as an access for data stealing by the intruder by checking the particular security code. The computational storage system 200 may identify a security level corresponding to the particular security code, based on data/table or the like indicating a correspondence relationship between pre-stored security codes and security levels.

In some implementations, the computational storage system 200 identifies the security level of the abnormal access based on a data pattern of the data request received from the abnormal access or a command type of the data request. For example, the computational storage system 200 (or the storage device 210) may determine/identify a data leakage path of the abnormal access, based on a data pattern of the data read request (or a data load request) received by the computational storage system 200 (or the storage device 210) or on a command type of the data read request (or the data load request), and may identify a security level corresponding to the determined data leakage path to be the security level of the abnormal access. For example, an abnormal access due to data leakage of hardware may directly transmit a data read request to the computational storage system 200 (or the storage device 210) through PCIe. The computational storage system 200 may check a data pattern or the like of the data read request and may identify the security level of the abnormal access to be a security level (for example, a fourth security level) corresponding to data leakage of hardware.

In operation S120, the computational storage system 200 may generate fake inference video data based on the security level of the abnormal access. In some implementations, the computational storage system 200 may obtain a model list of the target neural network model from a header of the target neural network model. The computational storage system 200 may select an alternative neural network model from at least one neural network model in the model list of the target neural network model, based on the security level of the abnormal access. Here, the computational storage system 200 may select, as the alternative neural network model, a neural network model having a higher matching ratio in the model list along with the increasing security level of the abnormal access. For example, referring to FIG. 5, when the security level of the abnormal access is the first security level (that is, Level 1), the computational storage system 200 may select, as the alternative neural network model, the neural network model 12 (that is, M #12) that is a neural network model having the highest matching ratio in the model list 217. For example, referring to FIG. 5, when the security level of the abnormal access is the fourth security level (that is, Level 4), the computational storage system 200 may select, as the alternative neural network model, the neural network model 232 (that is, M #232) that is a neural network model having the lowest matching ratio in the model list 217. However, the selection is not limited thereto, and the computational storage system 200 may, for example, select, as the alternative neural network model, a neural network model having a higher matching ratio in the model list along with the decreasing security level of the abnormal access, according to the use environment of the computational storage system 200 or a user setting.

The computational storage system 200 may obtain a plurality of generation time-data sets (e.g., a plurality of time-associated base data) of the alternative neural network model from a header of the alternative neural network model. The computational storage system 200 may select an alternative generation time-data set (e.g., a time-associated base data) from the plurality of generation time-data sets of the alternative neural network model, based on the security level of the abnormal access. Here, the computational storage system 200 may select, as the alternative generation time-data set (e.g., the alternative time-associated base data), a generation time-data set (e.g., the time-associated base data) including generation time more similar to target generation time along with the increasing security level of the abnormal access. For example, referring to FIG. 5, when the security level of the abnormal access is the first security level (that is, Level 1), the computational storage system 200 may select the neural network model 12 (that is, M #12) as the alternative neural network model and may select, as the alternative generation time-data set (e.g., the alternative time-associated base data), a generation time-data set (e.g., the time-associated base data) including generation time (for example, 11:20:24) most similar to the target generation time (for example, 11:00:24) from among the plurality of generation time-data sets (e.g., the plurality of time-associated base data) of the alternative neural network model (for example, the neural network model 12 (that is, M #12)). The computational storage system 200 may generate fake inference video data based on the 12^{th}-1 data set (for example, Base data #12-1 & Event table #12-1) of the alternative generation time-data set, by using the neural network model 12 (that is, M #12) that is the alternative neural network model. As another example, referring to FIG. 5, when the security level of the abnormal access is the fourth security level (that is, Level 4), the computational storage system 200 may select the neural network model 232 (that is, M #232) as the alternative neural network model and may select, as the alternative generation time-data set (e.g., the alternative time-associated base data), a generation time-data set (e.g., a time-associated base data) including generation time (for example, 23:20:34) most dissimilar to the target generation time (for example, 11:00:24) from among the plurality of generation time-data sets (e.g., the plurality of time-associated base data) of the alternative neural network model (for example, the neural network model 232 (that is, M #232)). The computational storage system 200 may generate fake inference video data based on the 232^{th}-N data set (for example, Base data #232-N & Event table #232-N) of the alternative generation time-data set, by using the neural network model 232 (that is, M #232) that is the alternative neural network model. However, the selection is not limited thereto and the computational storage system 200 may, for example, select, as the alternative generation time-data set (e.g., the alternative time-associated base data), a generation time-data set (e.g., a time-associated base data) including generation time more dissimilar to the target generation time along with the decreasing security level of the abnormal access, according to the use environment of the computational storage system 200 or the user setting.

In some implementations, the computational storage system 200 selects the alternative neural network model based on one of target generation time, a target generation day, and a target generation month, according to the user setting. Here, the target generation time may refer to time when data for which a read request is made by the abnormal access is generated, the target generation day may refer to a day when the data for which the read request is made by the abnormal access is generated, and the target generation month may refer to a month when the data for which the read request is made by the abnormal access is generated. For example, the computational storage system 200 may select, as the alternative neural network model, a neural network model having a generation time-data set (e.g., a time-associated base data) corresponding to the target generation time (for example, 11:00:24) from the at least one neural network model in the model list. For example, the computational storage system 200 may select, as the alternative neural network model, a neural network model having a generation time-data (e.g., a time-associated base data) set corresponding to the target generation day (for example, the 3rd day) from the at least one neural network model in the model list (that is, when original video data is generated on February 3rd, the computational storage system 200 may select, as the alternative neural network model, a neural network model having a generation time-data set (e.g., a time-associated base data) corresponding to the 3rd day of each month from the at least one neural network model in the model list). For example, the computational storage system 200 may select, as the alternative neural network model, a neural network model having a generation time-data set (e.g., a time-associated base data) corresponding to the target generation month (for example, March) from the at least one neural network model in the model list. The computational storage system 200 may generate fake inference video data based on the alternative neural network model and the alternative generation time-data set (e.g., the alternative time-associated base data) (for example, a generation time-data set including the target generation time), which are selected.

In operation S130, the computational storage system 200 outputs/transmits the generated fake inference video data to the abnormal access.

As described above, when the abnormal access is identified, the computational storage system 200 may generate the fake inference video data based on the alternative neural network model and the alternative generation time-data set (e.g., the alternative time-associated base data), and may output the fake inference video data to the abnormal access (that is, an intruder), and thus, the leakage of data stored in a storage device may be prevented, thereby enhancing data security.

In addition, in some implementations, the computational storage system 200 may identify the data leakage path of the abnormal access by analyzing the generated fake inference video data. This is because the fake inference video data is differently generated by the computational storage system 200 (or the computing device 220) according to a security level indicating a leakage path of the abnormal access.

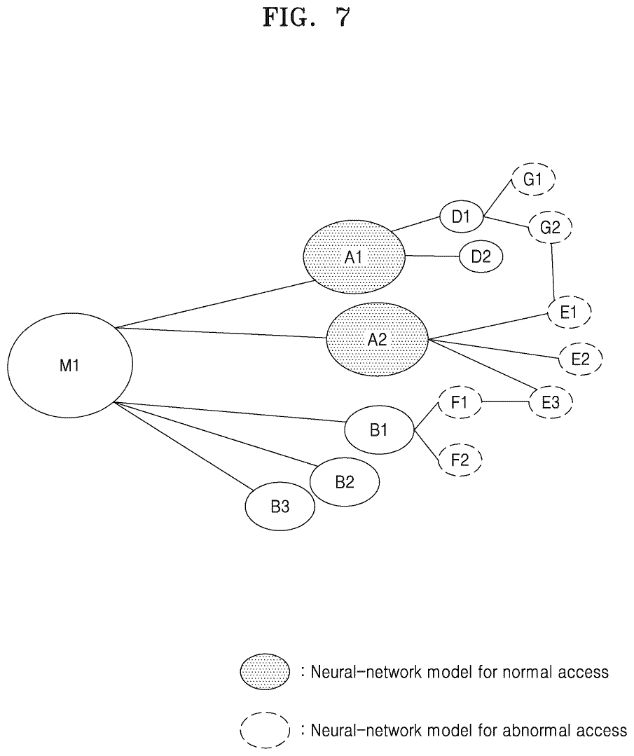

FIG. 7 is a diagram illustrating operations of a computational storage system, according to some implementations. In detail, FIG. 7 is a diagram illustrating an operation, performed by the computational storage system 200, of generating fake inference video data based on an alternative neural network model.

In FIG. 7, each circle may represent a neural network model or a sub-neural network model, a shaded circle may represent a neural network model that generates inference video data when a data read request is received from a normal access (for example, the host device 100 or the like), and a dashed circle may represent a neural network model that generates inference video data when a data read request is received from an abnormal access (for example, an intruder).

Referring to FIG. 7, the computational storage system 200 according to some implementations may store a plurality of neural network models and/or a plurality of sub-neural network models in the storage device 210. For example, in FIG. 7, the computational storage system 200 may include a neural network model M1 and a plurality of sub-neural network models (for example, A1, A2, B1, B2, B3, D1, D2, F1, F2, G1, G2, E1, E2, and E3) generated by subdividing the neural network model M1.

When a data read request is received from a normal access (for example, the host device 100 or the like), the computational storage system 200 may generate and output inference video data (referred to as original inference video data (or authentic inference video data), hereinafter) by using the sub-neural network model A1 and the sub-neural network model A2.

When a data read request is received from an abnormal access (for example, an intruder), the computational storage system 200 may generate and output inference video data (referred to as fake inference video data, hereinafter) by using the sub-neural network model A1 and alternative neural network models (for example, the sub-neural network models F1, F2, G1, G2, E1, E2, and E3) selected in place of the sub-neural network model A2. That is, the computational storage system 200 may provide the fake inference video data, instead of providing the original inference video data, to the abnormal access (for example, the intruder), thereby preventing the leakage of data of a device/system.

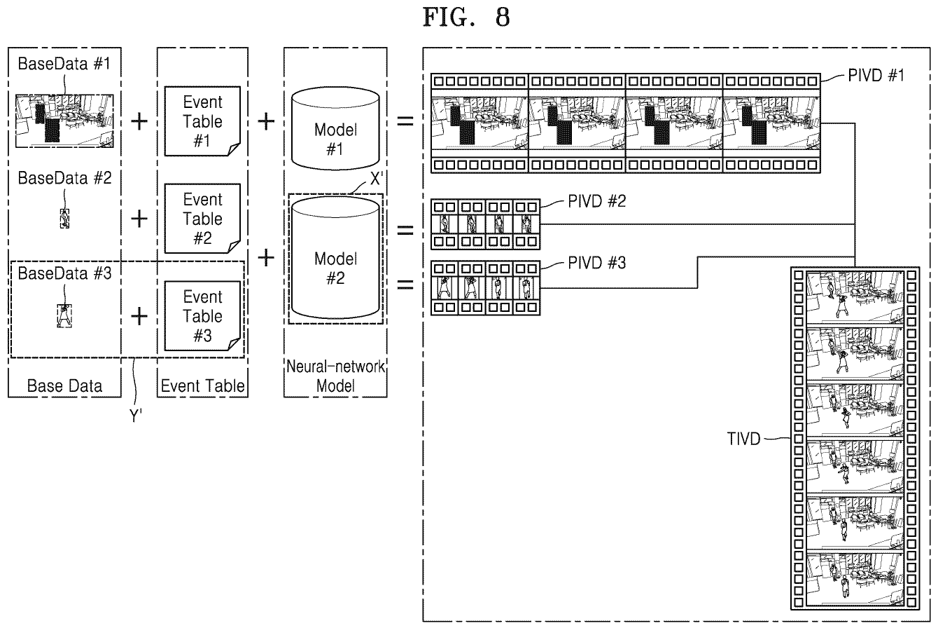

FIG. 8 is a diagram illustrating operations of a computational storage system, according to some implementations. In detail, FIG. 8 is a diagram illustrating an operation, performed by the computational storage system 200 (or the computing device 220), of generating fake inference video data based on a neural network model corresponding to at least one region in original video data.

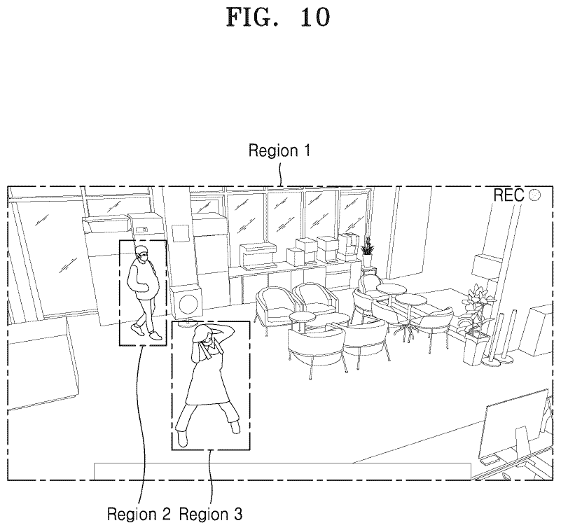

Referring to FIG. 8, in some implementations, the computing device 220 may generate at least one neural network model respectively corresponding to the at least one region, based on base data and an event table. For example, the computing device 220 may generate a first neural network model (that is, Model #1) corresponding to a first region (that is, Region 1), based on first base data (that is, Base data #1) and a first event table (that is, Event table #1) in the first region (that is, Region 1). Regions 1, 2, and 3 are labeled in FIG. 10.

In some implementations, when details of events occurring in pieces of base data of a plurality of regions are similar to each other, the computing device 220 may generate one neural network model corresponding to the plurality of regions, based on the pieces of base data of the plurality of regions and event tables of the plurality of regions. For example, when event details (for example, movements of a person 1 and a person 2) occurring in pieces of base data (for example, pieces of base data of the person 1 and the person 2) of a second region (that is, Region 2) and a third region (that is, Region 3) are similar to each other, the computing device 220 may generate a second neural network model (that is, Model #2) corresponding to the second region (that is, Region 2) and the third region (that is, Region 3), based on second base data (that is, Base data #2) and a second event table (that is, Event table #2) of the second region (that is, Region 2) as well as third base data (that is, Base data #3) and a third event table (that is, Event table #3) of the third region (that is, Region 3).

In some implementations, the computing device 220 may generate partial inference video data (PIVD) based on base data and an event table for each of at least one region, by using a neural network model. For example, the computing device 220 may generate first PIVD (that is, PIVD #1) based on the first base data (that is, Base data #1) and the first event table (that is, Event table #1) of the first region (that is, Region #1), by using the first neural network model (that is, Model #1). For example, the computing device 220 may generate second PIVD (that is, PIVD #2) based on the second base data (that is, Base data #2) and the second event table (that is, Event table #2) of the second region (that is, Region #2), by using the second neural network model (that is, Model #2). For example, the computing device 220 may generate third PIVD (that is, PIVD #3) based on the third base data (that is, Base data #3) and the third event table (that is, Event table #3) of the third region (that is, Region #3), by using the third neural network model (that is, Model #3).

In some implementations, the computing device 220 may generate total inference video data (TIVD) by synthesizing generated pieces of PIVD. For example, the computing device 220 may generate the TIVD by synthesizing the first PIVD (that is, PIVD #1), the second PIVD (that is, PIVD #2), and the third PIVD (that is, PIVD #3).

In some implementations, the computing device 220 may receive, from an abnormal access (for example, an intruder), a request (for example, a read request) for data (for example, inference video data) stored in the storage device 210. In FIG. 8, a neural network model for generating data requested by an abnormal access is assumed to be a second neural network model (that is, Model #2) X′. That is, the second neural network model (that is, Model #2) X′ may be a target neural network model. The computing device 220 may obtain a model list of the second neural network model (that is, Model #2) X′ by loading a header of the second neural network model (that is, Model #2) X′. The computing device 220 may select an alternative neural network model from at least one neural network model in the model list of the second neural network model (that is, Model #2) X′, based on a security level of the abnormal access. The computing device 220 may obtain generation time-data sets of the alternative neural network model by loading a header of the alternative neural network model. The computing device 220 may select an alternative generation time-data set from the generation time-data sets of the alternative neural network model, based on the security level of the abnormal access (see FIG. 6). Instead of generating the third PIVD (that is, PIVD #3) based on the third base data (that is, Base data #3) and a third event table (that is, Event table #3) Y by using the second neural network model (that is, Model #2) X′, the computing device 220 may generate fake inference video data based on a data set of the alternative generation time-data set, by using the alternative neural network model. The computing device 220 may output/transmit the generated fake inference video data to the abnormal access (for example, the intruder).

As described above, the computational storage system 200 (or the computing device 220) according to some implementations may generate and store a neural network model for each of at least one region in original video data (and base data and an event table of the region corresponding thereto) (low volume), instead of storing the original video data with a high volume, thereby maximizing the efficiency of a storage space in the storage device 210.

When there is an abnormal access to the computational storage system 200 according to some implementations, the computational storage system 200 (or the computing device 220) may generate and output fake inference video data based on an alternative neural network model and an alternative generation time-data set, thereby preventing data leakage due to the abnormal access. In addition, the leakage of data stored in a storage device may be prevented, thereby enhancing the security of the whole system.

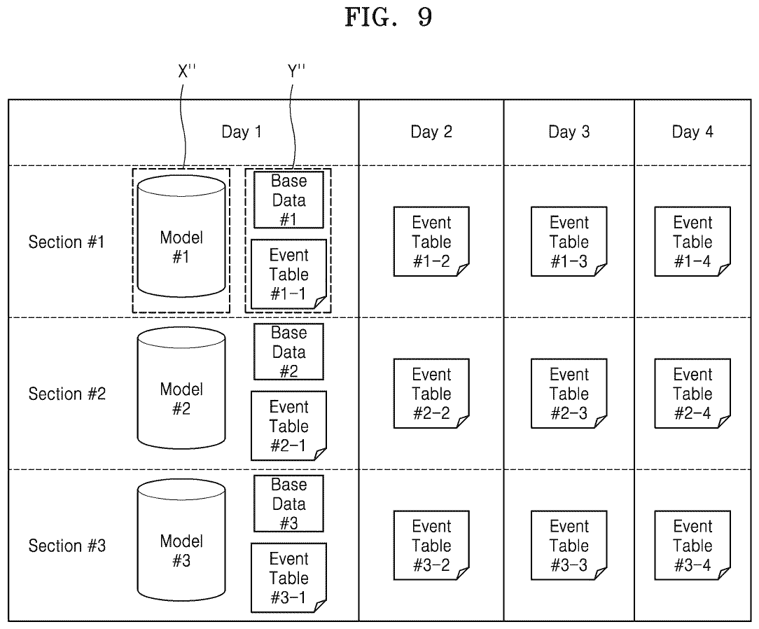

FIG. 9 is a diagram illustrating operations of a computational storage system, according to some implementations. In detail, FIG. 9 is a diagram illustrating an operation, performed by the computational storage system 200 (or the computing device 220), of generating fake inference video data based on a neural network model corresponding to at least one section in original video data.

In FIG. 9, a first section (that is, Section #1) is assumed to be a straight driving section, a second section (that is, Section #2) is assumed to be a corner driving section, and a third section (that is, Section #3) is assumed to be an intersection driving section. However, the sections are not limited thereto and may include various driving sections.

Referring to FIG. 9, in some implementations, the computing device 220 of the computational storage system 200 generates, from the original video data, base data (for example, first base data (that is, Base data #1), second base data (that is, Base data #2), and third base data (that is, Base data #3)) and an event table (for example, a first event table (that is, Event table #1-1), a second event table (that is, Event table #2-1), and a third event table (that is, Event table #3-1)) of Day 1. Here, the base data, which is data that is a base when a neural network model generates inference video data, may refer to basic raw data (for example, basic image data (1 picture) of an object) of at least one object in the original video data. The event table may refer to data in which events (for example, a movement of an object, a motion change, and the like) having occurred in the base data are respectively mapped to occurrence times. The base data and the event table may have, but are not limited to, a one-to-one relationship.

In some implementations, the computing device 220 divides the original video data into at least one section based on whether the data size of the event table increases to a threshold (for example, 200%) or more. For example, assuming that the data size of the event table increases to the threshold (for example, 200%) or more in the first section (that is, Section #1), the second section (that is, Section #2), and the third section (that is, Section #3) in the original video data, the computing device 220 may divide the original video data into the first section (that is, Section #1), the second section (that is, Section #2), and the third section (that is, Section #3).

In some implementations, the computing device 220 generates at least one neural network model respectively corresponding to the at least one section, based on the base data and the event table. For example, the computing device 220 may generate a first neural network model (that is, Model #1) corresponding to the first section (that is, Section #1), based on the first base data (that is, Base data #1) in the first section (that is, Section #1) and on the first event table (that is, Event table #1-1) of Day 1. For example, the computing device 220 may generate a second neural network model (that is, Model #2) corresponding to the second section (that is, Section #2), based on the second base data (that is, Base data #2) in the second section (that is, Section #2) and on the second event table (that is, Event table #2-1) of Day 1. For example, the computing device 220 may generate a third neural network model (that is, Model #1) corresponding to the third section (that is, Section #3), based on the third base data (that is, Base data #3) in the third section (that is, Section #3) and on the third event table (that is, Event table #3-1) of Day 1.

In some implementations, the computing device 220 generates an event table associated with each base data, for each date. For example, the computing device 220 may generate a first event table (that is, Event table #1-2) of Day 2, which is associated with the first base data (that is, Base data #1) of the first section (that is, Section #1) on Day 2, may generate a first event table (that is, Event table #1-3) of Day 3, which is associated with the first base data (that is, Base data #1) on Day 3, and may generate a first event table (that is, Event table #1-4) of Day 4, which is associated with the first base data (that is, Base data #1) on Day 4. For example, the computing device 220 may generate a second event table (that is, Event table #2-2) of Day 2, which is associated with the second base data (that is, Base data #2) of the second section (that is, Section #2) on Day 2, may generate a second event table (that is, Event table #2-3) of Day 3, which is associated with the second base data (that is, Base data #2) on Day 3, and may generate a second event table (that is, Event table #2-4) of Day 4, which is associated with the second base data (that is, Base data #2) on Day 4. For example, the computing device 220 may generate a third event table (that is, Event table #3-2) of Day 2, which is associated with the third base data (that is, Base data #3) of the third section (that is, Section #3) on Day 2, may generate a third event table (that is, Event table #3-3) of Day 3, which is associated with the third base data (that is, Base data #3) on Day 3, and may generate a third event table (that is, Event table #3-4) of Day 4, which is associated with the third base data (that is, Base data #3) on Day 4.

In some implementations, the computing device 220 generates inference video data based on base data and an event table, by using a neural network model for each section. In some implementations, the computing device 220 generates inference video data based on base data and an event table generated by date, by using a neural network model for each section. For example, the computing device 220 may generate inference video data (that is, “Day 1”) of the first section (that is, Section #1) (for example, a straight driving section) on Day 1 based on the first base data (that is, Base data #1) and the first event table (that is, Event table #1-1) of Day 1, by using the first neural network model (that is, Model #1), may generate inference video data (that is, “Day 2”) of the first section (that is, Section #1) on Day 2 based on the first base data (that is, Base data #1) and the first event table (that is, Event table #1-2) of Day 2, by using the first neural network model (that is, Model #1), may generate inference video data (that is, “Day 3”) of the first section (that is, Section #1) on Day 3 based on the first base data (that is, Base data #1) and the first event table (that is, Event table #1-3) of Day 3, by using the first neural network model (that is, Model #1), and may generate inference video data (that is, “Day 4”) of the first section (that is, Section #1) on Day 4 based on the first base data (that is, Base data #1) and the first event table (that is, Event table #1-4) of Day 4, by using the first neural network model (that is, Model #1). For example, the computing device 220 may generate inference video data (that is, “Day 1”) of the second section (that is, Section #2) (for example, a corner driving section) on Day 1 based on the second base data (that is, Base data #2) and the second event table (that is, Event table #2-1) of Day 1, by using the second neural network model (that is, Model #2), may generate inference video data (that is, “Day 2”) of the second section (that is, Section #2) on Day 2 based on the second base data (that is, Base data #2) and the second event table (that is, Event table #2-2) of Day 2, by using the second neural network model (that is, Model #2), may generate inference video data (that is, “Day 3”) of the second section (that is, Section #2) on Day 3 based on the second base data (that is, Base data #2) and the second event table (that is, Event table #2-3) of Day 3, by using the second neural network model (that is, Model #2), and may generate inference video data (that is, “Day 4”) of the first section (that is, Section #2) on Day 4 based on the second base data (that is, Base data #2) and the second event table (that is, Event table #2-4) of Day 4, by using the second neural network model (that is, Model #2). For example, the computing device 220 may generate inference video data (that is, “Day 1”) of the third section (that is, Section #3) (for example, a corner driving section) on Day 1 based on the third base data (that is, Base data #3) and the third event table (that is, Event table #3-1) of Day 1, by using the third neural network model (that is, Model #3), may generate inference video data (that is, “Day 2”) of the third section (that is, Section #3) on Day 2 based on the third base data (that is, Base data #3) and the third event table (that is, Event table #3-2) of Day 2, by using the third neural network model (that is, Model #3), may generate inference video data (that is, “Day 3”) of the third section (that is, Section #3) on Day 3 based on the third base data (that is, Base data #3) and the third event table (that is, Event table #3-3) of Day 3, by using the third neural network model (that is, Model #3), and may generate inference video data (that is, “Day 4”) of the third section (that is, Section #3) on Day 4 based on the third base data (that is, Base data #3) and the third event table (that is, Event table #3-4) of Day 4, by using the third neural network model (that is, Model #3).

In some implementations, the computing device 220 receives, from an abnormal access (for example, an intruder or the like), a request for data (for example, inference video data) stored in the storage device 210. In FIG. 9, it is assumed that a neural network model for generating the data requested by the abnormal access is a first neural network model (that is, Model #1) X″ and the data requested by the abnormal access is the inference video data (that is, “Day 1”) of the first section (that is, Section #1) (for example, a straight driving section) on Day 1, the inference data (that is, “Day 1”) being based on the first base data (that is, Base data #1) and the first event table (that is, Event table #1-1) of Day 1. That is, the first neural network model (that is, Model #1) X″ may be a target neural network model. The computing device 220 may obtain a model list of the first neural network model (that is, Model #1) X″ by loading a header of the first neural network model (that is, Model #1) X″. The computing device 220 may select an alternative neural network model from at least one neural network model in the model list of the first neural network model (that is, Model #1) X″, based on a security level of the abnormal access. The computing device 220 may obtain generation time-data sets of the alternative neural network model by loading a header of the alternative neural network model. The computing device 220 may select an alternative generation time-data set from the generation time-data sets of the alternative neural network model, based on the security level of the abnormal access (see FIG. 6). For example, when the second neural network model (that is, Model #2) is selected as the alternative neural network model, the computing device 220 may select, as the alternative generation time-data set, a generation time-data set including generation time similar to target generation time (for example, Day 1) from among generation time-data sets of the second neural network model (that is, Model #2). Instead of generating the inference video data (that is, “Day 1”) of the first section (that is, Section #1) (for example, a straight driving section) on Day based on the first base data (that is, Base data #1) and a first event table (that is, Event table #1-1) Y″ of Day 1 by using the first neural network model (that is, Model #1) X″, the computing device 220 may generate fake inference video data based on a data set of the alternative generation time-data set, by using the alternative neural network model. The computing device 220 may output/transmit the generated fake inference video data to the abnormal access (for example, the intruder).

Although it is described in FIG. 4 that a neural network model corresponding to each of the at least one section is generated for convenience of description, the models are not limited thereto, and when details of events occurring in pieces of base data of a plurality of sections are similar to each other (for example, a straight section and another straight section, a corner section and another corner section, or the like), the computing device 220 according to some implementations may generate one neural network model corresponding to the plurality of sections, based on the pieces of base data of the plurality of sections and event tables of the plurality of sections.

As described above, instead of storing high-volume original video data (for example, original video data on Day 1 to Day 4), the computational storage system 200 (or the computing device 220) according some implementations may generate and store a neural network model for each of at least one section in the original video data (and base data and an event table of the section) (low volume), thereby maximizing the efficiency of a storage space in the storage device 210.

In addition, when there is an abnormal access to the computational storage system 200 according to some implementations, the computational storage system 200 (or the computing device 220) may generate and output fake inference video data based on an alternative neural network model and an alternative generation time-data set, thereby preventing data leakage due to the abnormal access. In addition, the leakage of data stored in the storage device may be prevented, thereby enhancing the security of the whole system.

FIG. 10 illustrates an example of original inference video data according to some implementations.

Referring to FIG. 10, illustrated is an example of data (referred to as original inference video data (or authentic inference video data), hereinafter) for which a request (for example, a read request) made by an abnormal access (for example, an intruder), according to some implementations. The original inference video data may include a first region (that is, Region 1, for example, a background region), a second region (that is, Region 2, for example, a region of person 1), and a third region (that is, Region 3, for example, a region of person 2). For example, the second region (that is, Region 2, for example, the region of person 1) may be in the upper left (that is, on the left of the third region (that is, Region 3, for example, the region of person 2)) in the entire area of the original inference video data.

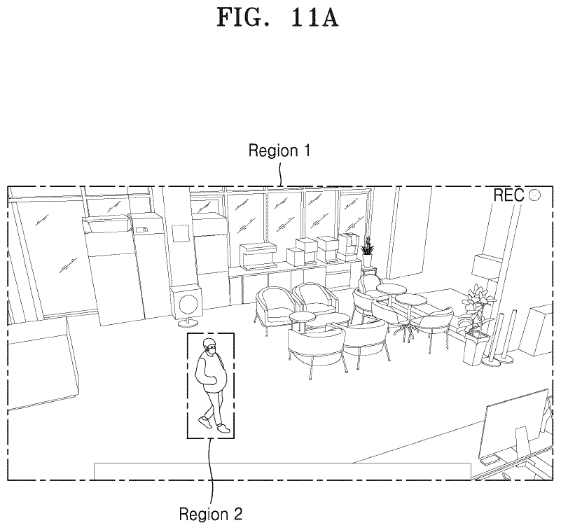

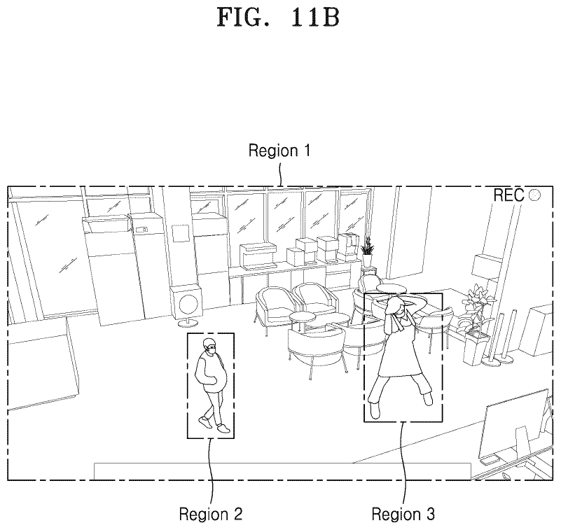

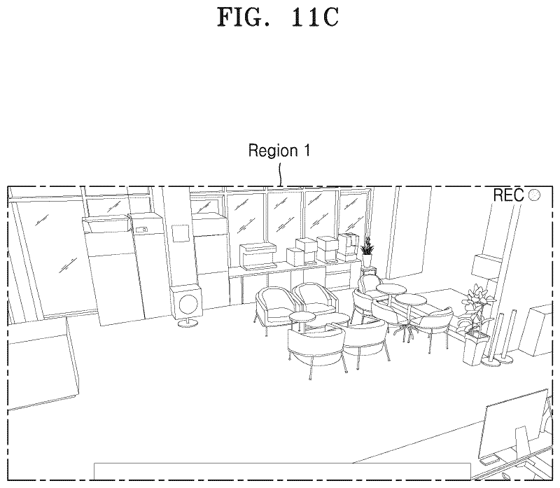

When the abnormal access is identified, the computational storage system 200 (or the computing device 220) according to some implementations may generate and output fake inference video data of FIGS. 11A to 11C based on an alternative neural network model and an alternative generation time-data set.

The fake inference video data according to some implementations may be differently generated according to a data leakage path of the abnormal access (this is because the fake inference video data is generated based on a security level indicating the data leakage path of the abnormal access).

FIGS. 11A to 11C each illustrate an example of fake inference video data according to some implementations.

In FIGS. 11A to 11C, the computational storage system 200 (or the computing device 220) according to some implementations may generate fake inference video data to be different from each other according to a data leakage path (for example, the leakage of authentication data of a website, the leakage of data of hardware, the leakage of authentication data of a network, or the like) of an abnormal access. In this way, by analyzing the fake inference video data afterwards, the data leakage path of the abnormal access may be identified, thereby enhancing the security of a system/device.

Referring to FIG. 11A, illustrated is an example of fake inference video data generated by the computational storage system 200 (or the computing device 220) according to some implementations. First fake inference video data of FIG. 11A may be fake inference video data in the case where authentication data of a website is leaked. However, the inauthentic access is not limited thereto, and the first fake inference video data of FIG. 11A may be fake inference video data in various data leakage cases. For example, the first fake inference video data of FIG. 11A may include a first region (that is, Region 1, for example, a background region) and a second region (that is, Region 2, for example, a region of person 1). That is, as compared with the original inference video data of FIG. 10, it may be confirmed that a third region (that is, Region 3, for example, the region of person 2) is deleted from the first fake inference video data of FIG. 11A. In addition, as compared with the original inference video data of FIG. 10, it may be confirmed that the second region (that is, Region 2, for example, the region of person 1) is in the lower central portion of the entire area in the first fake inference video data. That is, as compared with the original inference video data (for example, FIG. 10), a person appearing in the first fake inference video data as well as the appearance time, position, action, and/or details (for example, clothes, expression, and the like) of the person may vary.

Referring to FIG. 11B, illustrated is an example of fake inference video data generated by the computational storage system 200 (or the computing device 220) according to some implementations. Second fake inference video data of FIG. 11B may be fake inference video data in the case where data of hardware is leaked. However, the inauthentic access is not limited thereto, and the second fake inference video data of FIG. 11B may be fake inference video data in various data leakage cases. For example, the second fake inference video data of FIG. 11B may include a first region (that is, Region 1, for example, a background region), a second region (that is, Region 2, for example, a region of person 1), and a third region (that is, Region 3, for example, a region of person 2). In addition, as compared with the original inference video data of FIG. 10, it may be confirmed that the position of the third region (that is, Region 3, for example, the region of person 2) is changed to the right side in the entire area in the second fake inference video data. That is, as compared with the original inference video data (for example, FIG. 10), a person appearing in the second fake inference video data as well as the appearance time, position, action, and/or details (for example, clothes, expression, and the like) of the person may vary.

Referring to FIG. 11C, illustrated is an example of fake inference video data generated by the computational storage system 200 (or the computing device 220) according to some implementations. Third fake inference video data of FIG. 11C may be fake inference video data in the case where authentication data of a network is leaked. However, the inauthentic access is not limited thereto, and the third fake inference video data of FIG. 11C may be fake inference video data in various data leakage cases. For example, the third fake inference video data of FIG. 11C may include only a first region (that is, Region 1, for example, a background region). That is, as compared with the original inference video data of FIG. 10, it may be confirmed that the second region (that is, Region 2, for example, the region of person 1) and the third region (that is, Region 3, for example, the region of person 2) are deleted from the third fake inference video data of FIG. 11C. That is, as compared with the original inference video data (for example, FIG. 10), a person appearing in the third fake inference video data as well as the appearance time, position, action, and/or details (for example, clothes, expression, and the like) of the person may vary.

As described above, when an abnormal access to the computational storage system 200 according to some implementations is identified, the computational storage system 200 (or the computing device 200) may not generate/output original inference video data but may generate/output fake inference video data instead of the original inference video data, thereby preventing data leakage. That is, the computational storage system 200 may provide, to the abnormal access (for example, an intruder), the fake inference video data instead of the original inference video data, thereby preventing the leakage of data of a device/system.

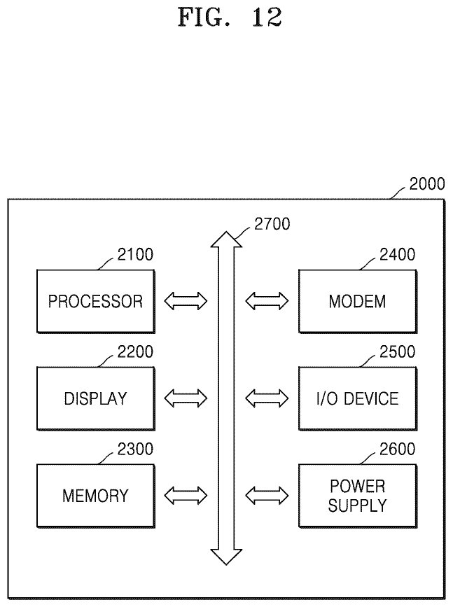

FIG. 12 is a block diagram illustrating an example of an electronic device. Referring to FIG. 12, an electronic device 2000 may include a processor 2100, a display 2200, a memory 2300, a modem 2400, an input/output device 2500, and a power supply 2600.

The processor 2100 is a device for controlling all operations of the electronic device 2000. The processor 2100 may perform data processing on input data by running an application. The application include a plurality of data operations related to the performance of a task, for example, an arithmetic operation, a convolution operation, a polling operation, and the like. For example, when the processor 2100 performs a task (for example, the generation of inference video data corresponding to original video data) that is based on a neural network, the application may include a plurality of data operations, which are based on at least one of various neural networks that are included in the application, as well as input and output sizes, weights, biases, and the like of the plurality of data operations. For example, a neural network model, which is a generative model, may be a deep-fake model.

The processor 2100 may be implemented by a CPU, a GPU, a DSP, an FPGA, an ASIC, an NPU, or the like. However, the processor 2100 is not limited thereto, and the processor 2100 may be implemented by various circuits configured to perform data processing, for example, a data operation, required to perform an assigned task.

The processor 2100 may divide original video data into at least one region (or at least one section) according to preset criteria (for example, whether the size of an event table increases to a threshold (for example, 200%) or more) and may generate a neural network model corresponding to the at least one region or the at least one section.

The processor 2100 may generate, by using the generated neural network model, inference video data of a region (or a section) corresponding thereto, based on base data and an event table of the corresponding region (or the corresponding section). Here, the inference video data may refer to data generated by performing inference based on the original video data of the corresponding region (or the corresponding section).

The processor 2100 may determine whether to store the base data, the event table, and the neural network model instead of storing the original video data, based on a matching ratio between the original video data and the inference video data.

When the matching ratio between the original video data and the inference video data is less than a preset threshold, the processor 2100 may regenerate the neural network model based on the base data and the event table of the corresponding region (the corresponding section) and may regenerate the inference video data of the corresponding region (the corresponding section) by using the regenerated neural network model.

When the number of uses of a neural network model increases to a threshold or more, the processor 2100 according to some implementations may generate at least one sub-neural network models by subdividing the neural network model.

The processor 2100 according to some implementations may generate inference video data corresponding to original video data, based on base data and an event table both generated from the original video data, by using a plurality of neural network models, and when an abnormal access to the memory 2300 is detected, may generate and output fake inference video data based on a security level of the abnormal access. Here, the security level of the abnormal access may indicate a data leakage path of the abnormal access. The security level (for example, a first security level (that is, Level 1)) may further include subdivided security levels (for example, a 1^{st}-1 security level (that is, Level 1-1), a 1^{st}-2 security level (that is, Level 1-2), . . . , and a 1^{st}-N security level (that is, Level 1-N)) according to a use environment of the memory 2300 or a selection by a user.

The processor 2100 may identify the security level of the abnormal access based on at least one of security code of the abnormal access, a data pattern of a data request received from the abnormal access, and a command type of the data request.

The processor 2100 may select, as an alternative neural network model, a neural network model corresponding to the security level, based on a header of a target neural network model, may select, as an alternative generation time-data set, a generation time-data set corresponding to the security level from among a plurality of generation time-data sets of the alternative neural network model, based on a header of the alternative neural network model, and may generate fake inference video data based on the alternative neural network model and the alternative generation time-data set. Here, the target neural network model may refer to a neural network model for generating data requested by the abnormal access, from among a plurality of neural network models.

When there is no generation time-data set corresponding to the security level from among a plurality of generation time-data sets of the alternative neural network model, the processor 2100 according to some implementations may reselect the alternative neural network model from at least one neural network model in a model list of the target neural network model.

The display 2200 may output a data processing result of the processor 2100 to a user via a display panel.

The memory 2300 may include volatile memory, such as SRAM, DRAM, or synchronous DRAM (SDRAM), and/or nonvolatile memory, such as PRAM, MRAM, ReRAM, or FRAM.

The memory 2300 may include a plurality of storage devices, and each of the plurality of storage devices may be implemented like the computational storage system 200 described above with reference to FIGS. 1 to 11C. In addition, the memory 2300 may be connected to each of the processor 2100, the display 2200, the modem 2400, the input/output device 2500, and the power supply 2600 via a channel 2700, and the channel 2700 may be used for data exchange between the memory 2300 and each of the processor 2100, the display 2200, the modem 2400, the input/output device 2500, and the power supply 2600.

The modem 2400 may support at least one of various wireless/wired communication protocols to communicate with a device or a system external to the electronic device 2000. The input/output device 2500 may mediate communication between a user and the electronic device 2000 via a user interface including various input/output interfaces. The power supply 2600 may supply power to the electronic device 2000 and may perform overall power-related management on the electronic device 2000.

Use of the electronic device 2000 as described above may allow the processor 2100 to generate a neural network model for each region (or for each section), to generate inference video data for each region (or for each section) by using the neural network model for each region (or for each section), and to store base data, an event table, and the neural network model (low volume) instead of original video data (high volume), thereby maximizing the efficiency of a storage space of the memory 2300.

In addition, when there is an abnormal access to the memory 2300, use of the electronic device 2000 according to some implementations may allow the processor 2100 to generate and output fake inference video data based on an alternative neural network model and an alternative generation time-data set, thereby preventing data leakage due to the abnormal access. Furthermore, the processor 2100 may identify a data leakage path of the abnormal access by analyzing the fake inference video data, and thus, the security of the electronic device 2000 may be enhanced.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While examples have been particularly shown and described with reference to embodiments thereof, it will be understood that various changes in form and details may be made therein without departing from the spirit and scope of this disclosure.

What is claimed is:

1. A computational storage system comprising:
a storage device configured to store a plurality of neural network models and a plurality of base data, wherein the plurality of base data respectively correspond to the plurality of neural network models, and
wherein the plurality of base data comprise different respective portions of original video data; and
a computing device configured to:
based on identification of an abnormal access to the computational storage system, generate fake inference video data using a first neural network model of the plurality of neural network models,
wherein the first neural network model corresponds to first base data, of the plurality of base data, that changes at least a portion of second base data, of the plurality of base data, for which video generation is requested through the abnormal access; and
output the generated fake inference video data.

2. The computational storage system of claim 1, wherein the computing device is configured to select the first neural network model from among the plurality of neural network models based on a security level indicative of a data leakage path of the abnormal access.

3. The computational storage system of claim 2, wherein the computing device is configured to identify the security level based on:
a data pattern of a data request received through the abnormal access,
a command type of the data request, or
a security code received through the abnormal access.

4. The computational storage system of claim 1, wherein the storage device is configured to store, for each of the plurality of neural network models:
an indication of one or more times for which the neural network model is configured to generate video data,
an indication of a similarity between video data generated using the neural network model and video data generated using at least one other neural network model of the plurality of neural network models, and
an indication of one or more times for which each of the at least one other neural network models is configured to generate video data.

5. The computational storage system of claim 1, wherein the second base data for which video generation is requested through the abnormal access includes data representative of an object included in the original video data, and
wherein the first base data changes the data representative of the object, such that the fake inference video data includes the changed object.

6. The computational storage system of claim 1, wherein the second base data for which video generation is requested through the abnormal access corresponds to a target neural network model of the plurality of neural network models, and wherein the computing device is configured to:
select, as the first neural network model, an alternative neural network model of the plurality of neural network models based on a similarity between video data generated using the alternative neural network model and video data generated using the target neural network model;
select a time-associated base data, from among a plurality of time-associated base data corresponding to the alternative neural network model, based on a security level corresponding to the abnormal access; and
generate the fake inference video data based on the alternative neural network model and the selected time-associated base data.

7. The computational storage system of claim 6, wherein selecting the alternative neural network model comprises:
selecting, as the first neural network model, a candidate alternative neural network model of the plurality of neural network models, and
in response to determining that a plurality of candidate time-associated base data corresponding to the candidate alternative neural network model lack correspondence with the security level, performing reselection to select the alternative neural network model as the first neural network model.

8. The computational storage system of claim 1, wherein the first neural network model is trained based on the first base data.

9. An operation method of a computational storage system configured to store a plurality of neural network models, the operation method comprising:
receiving a data request through an abnormal access to the computational storage system, wherein the data request indicates a request to generate video data using a target neural network model of the plurality of neural network models;
identifying a security level of the abnormal access;
generating fake inference video data using an alternative neural network model, different from the target neural network model, based on the security level; and
outputting the fake inference video data,
wherein the security level indicates a data leakage path of the abnormal access.

10. The operation method of claim 9, wherein identifying the security level of the abnormal access comprises identifying the security level based on a security code provided through the abnormal access.

11. The operation method of claim 9, wherein identifying the security level of the abnormal access comprises identifying the security level based on a data pattern or a command type of the data request received through the abnormal access.

12. The operation method of claim 9, comprising storing, in a header of each of the plurality of neural network models, and
the header of each of the plurality of neural network models comprises:
an indication of one or more times for which the neural network model is configured to generate video data,
an indication of a similarity between video data generated using the neural network model and video data generated using at least one other neural network model of the plurality of neural network models, and
an indication of one or more times for which each of the at least one other neural network models is configured to generate video data.

13. The operation method of claim 9, wherein the alternative neural network model is trained based on first base data,
wherein the target neural network model is trained based on second base data, and
wherein the first base data changes at least a portion of the second base data.

14. The operation method of claim 13, wherein the changed at least a portion of the second base data includes data representative of a object, such that the fake inference video data includes the changed object.

15. The operation method of claim 9, wherein generating the fake inference video data comprises:
selecting the alternative neural network model from among the plurality of neural network models based on a similarity between video data generated using the alternative neural network model and video data generated using the target neural network model;
selecting a time-associated base data, from among a plurality of time-associated base data corresponding to the alternative neural network model, based on the security level; and
generate the fake inference video data based on the alternative neural network model and the selected time-associated base data.

16. The operation method of claim 15, wherein selecting the alternative neural network model comprises:
selecting a candidate alternative neural network model of the plurality of neural network models, and
in response to determining that a plurality of candidate time-associated base data corresponding to the candidate alternative neural network model lack correspondence with the security level, performing reselection to select the alternative neural network model.

17. An electronic device comprising:
a memory storing a plurality of neural network models; and
a processor configured to:
generate inference video data corresponding to original video data, based on base data and an event table that are generated from the original video data, by using the plurality of neural network models;
based on identification of an abnormal access to the memory, select a first neural network model of the plurality of neural network models; and
generate and output fake inference video data based on a security level of the abnormal access.

18. The electronic device of claim 17, wherein a data request received through the abnormal access indicates a request to generate video data using a target neural network model of the plurality of neural network models, the target neural network model different from the first neural network model, and
wherein the fake inference video data is generated in response to the data request.

19. The electronic device of claim 18, wherein the inference video data is generated using the target neural network model.

20. The electronic device of claim 18, wherein the first neural network model is trained based on first base data,
wherein the target neural network model is trained based on second base data, and
wherein the first base data changes at least a portion of the second base data.
